(19) United States
(12) Patent Application Publication
(10) Pub. No.: US 2020/0364346 A1
(43) Pub. Date: Nov. 19, 2020

(54) SECURE DESIGN AND DEVELOPMENT: INTERTWINED MANAGEMENT AND TECHNOLOGICAL SECURITY ASSESSMENT FRAMEWORK

(71) Applicant: Battelle Memorial Institute, Richland, WA (US)

(72) Inventors: Sri Nikhil Gupta Gourisetti, Richland, WA (US); Scott R. Mix, Lansdale, PA (US); Jessica L. Smith, Palouse, WA (US); Michael E. Mylrea, Alexandria, VA (US); Christopher A. Bonebrake, Richland, WA (US); Paul M. Skare, Richland, WA (US); David O. Manz, Kennewick, WA (US)

(73) Assignee: Battelle Memorial Institute, Richland, WA (US)

(21) Appl. No.: 16/840,202

(22) Filed: Apr. 3, 2020

Related U.S. Application Data
(60) Provisional application No. 62/845,122, filed on May 8, 2019.

(51) Int. Cl. G06F 21/57; G06F 8/77; G06F 8/20

(52) U.S. Cl. CPC G06F 21/577; G06F 2221/033; G06F 8/20; G06F 8/77

(57) ABSTRACT

Apparatus and methods are disclosed for producing configuration recommendations and implementing those recommendations in a computing environment. In some examples, a browser-based tool is provided that allows hardware and software developers to assess the maturity level of their design and development processes, allows management to determine desired maturity levels in seven domains, and allows developers to monitor process maturity improvements against management goals. The disclosed technologies can be used by commercial software developers as well as internal development organizations.

### CROSS-REFERENCE TO RELATED APPLICATIONS

This application claims the benefit of U.S. Provisional Application No. 62/845,122, entitled “SECURE DESIGN AND DEVELOPMENT: INTERTWINED MANAGEMENT AND TECHNOLOGICAL SECURITY ASSESSMENT FRAMEWORK,” filed May 8, 2019, which application is incorporated herein by reference in its entirety.

### ACKNOWLEDGMENT OF GOVERNMENT SUPPORT

This disclosure was made with Government support under Contract DE-AC0576RL01830 awarded by the U.S. Department of Energy. The Government has certain rights in the invention.

### BACKGROUND

Securing the critical control components in modern hardware and software systems is herculean task, because software developers rush products to market without fully considering cybersecurity as part of their design and deployment criteria. Currently, no widely available, quantifiable, and repeatable method can evaluate the cybersecurity of energy delivery system (EDS) operational technology (OT) components throughout their entire lifecycle. Thus, there is ample opportunity for improvement in software and manufacturer tools used in product development to meet end-user requirements.

### SUMMARY

Apparatus and methods are disclosed for producing configuration recommendations and implementing those recommendations in a computing environment. For example, computing environments associated with power grids and other critical infrastructure may receive particular benefit from application of disclosed technologies, although as will be readily understood to one of ordinary skill in the art having the benefit of the present disclosure, disclosed methods and apparatus may be deployed to any suitable computer development environment.

In one particular example, a computer-implemented methods includes A method comprising: producing management priority data indicating a respective prescribed maturity level for a plurality of enumerated domains in a computing environment, producing technical assessment data indicating an expected maturity level for each of the plurality of domains in the computing environment, and evaluating the management priority data and the technical assessment data to produce at least one recommended configuration change to modify the computing environment, the recommended configuration change being selected to reduce susceptibility of the computing environment to at least one vulnerability. In some examples, the method further includes performing an operation in the computing environment to implement the recommended configuration change.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed subject matter will become more apparent from the following Detailed Description, which proceeds with reference to the accompanying figures.

### BRIEF DESCRIPTION OF THE DRAWINGS

FIG. 1 is a block diagram of a computing environment in which certain apparatus and methods according to the disclosed technology can be implemented.

FIG. 2 is a flow chart outlining an example method of producing recommended configuration changes for mitigating vulnerabilities in a computing environment, as can be implemented in certain examples of the disclosed technology.

FIGS. 3A-3F is a flow chart outlining a further detailed example method of producing recommended configuration changes for mitigating vulnerabilities in a computing environment, as can be implemented in certain examples of the disclosed technology.

FIG. 4 is an illustration of a management priorities display in a graphical user interface, as can be implemented in certain examples of the disclosed technology.

FIG. 5 is a depiction of a computer-implemented graphical user interface display for a comparative evaluation sub-application, as can be implemented in certain examples of the disclosed technology.

FIG. 6 is a depiction of a computer-implemented graphical user interface display of a pie summary display, as can be implemented in certain examples of the disclosed technology.

FIG. 7 is a depiction of a computer-implemented graphical user interface display of an illustrative timeline graph, as can be implemented in certain examples of the disclosed technology.

FIG. 8 is a depiction of a computer-implemented graphical user interface display of a pie summary display illustrating MIL0 maturity of the organization at date D1, as can be implemented in certain examples of the disclosed technology.

FIG. 9 is a depiction of a computer-implemented graphical user interface display of a pie summary display illustrating MIL1 maturity of the organization at date D2, as can be implemented in certain examples of the disclosed technology.

FIG. 10 is a depiction of a computer-implemented graphical user interface display of a pie summary display illustrating MIL2 maturity of the organization at date D3, as can be implemented in certain examples of the disclosed technology.

FIG. 11 is a depiction of a computer-implemented graphical user interface display of a pie summary display illustrating MIL3 maturity of the organization at date D4, as can be implemented in certain examples of the disclosed technology.

FIG. 12 is a depiction of a computer-implemented graphical user interface display of a pie summary display showing background and foundation domain, as can be implemented in certain examples of the disclosed technology.

FIGS. 13A-13B is a depiction of a computer-implemented graphical user interface display of a pie summary display showing Design domain over levels MIL1-3, as can be implemented in certain examples of the disclosed technology.

FIG. 14 is a depiction of a computer-implemented graphical user interface display of a pie summary display showing Build domain over levels MIL1-3, as can be implemented in certain examples of the disclosed technology.

FIG. 15 is a depiction of a computer-implemented graphical user interface display of a pie summary display showing Test domain over levels MIL1-3, as can be implemented in certain examples of the disclosed technology.

FIG. 16 is a depiction of a computer-implemented graphical user interface display of a pie summary display showing Integrate domain over levels MIL1-3, as can be implemented in certain examples of the disclosed technology.

FIG. 17 is a depiction of a computer-implemented graphical user interface display of a pie summary display showing Deploy domain over levels MIL1-3, as can be implemented in certain examples of the disclosed technology.

FIG. 18 is a depiction of a computer-implemented graphical user interface display of a pie summary display showing Lifecycle and End-of-Life domain over levels MIL1-3, as can be implemented in certain examples of the disclosed technology.

FIG. 19 is a chart illustrating CWE mitigation over time in a particular example of the disclosed technology.

FIG. 20 is a chart illustrating a reflection of organizational maturity on various domains in a particular example of the disclosed technology.

FIG. 21 depicts a computer-implemented graphical display for selecting and displaying prescribed and anticipated maturity levels, as can be implemented in certain examples of the disclosed technology.

FIG. 22 depicts a computer-implemented graphical display for selecting and displaying prescribed and anticipated maturity levels, as can be implemented in certain examples of the disclosed technology.

FIGS. 23A-23C depicts a computer-implemented graphical display for selecting and displaying expected maturity levels, as can be implemented in certain examples of the disclosed technology.

FIG. 24 depicts a computer-implemented graphical user interface displaying an alternative arrangement of a pie summary chart, as can be implemented in certain examples of the disclosed technology.

FIG. 25 depicts a computer-implemented graphical user interface displaying an alternative arrangement of a pie summary chart, as can be implemented in certain examples of the disclosed technology.

FIG. 26 illustrates an example of a computing environment in which certain apparatus and methods can be implemented according to the disclose technology.

FIG. 27 depicts a computer-implemented graphical display for selecting and displaying prescribed and anticipated maturity levels, as can be implemented in certain examples of the disclosed technology.

FIG. 28 is a depiction of a computer-implemented graphical user interface display of a MIL summary display, as can be implemented in certain examples of the disclosed technology.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “evaluate,” “determine,” “adjust,” “deploy,” and “perform” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including microcontrollers or servers that include computing hardware). Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as a process executing on any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be readily understood to one of ordinary skill in the relevant art that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods can also be implemented by specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)). The integrated circuit or specialized computing hardware can be embedded in or coupled to components of energy delivery systems, including, for example, electrical generators, inverted-connected power sources, energy storage devices, transforms, AC/DC and DC/AC converters, and power transmission systems.

### II. Introduction to the Disclosed Technology

Examples of apparatus and methods to implement a secure design and development cybersecurity capability maturity model are disclosed. These examples can enable designers, producers, and integrators of the connected devices and systems to improve the cybersecurity of their developed products. This allows system developers, testers, end-users, and other stakeholders to provide a number of different practical applications, including embedding cybersecurity in the design, development, manufacture, testing, deployment, maintenance, and disposal of critical operational technology, including for energy delivery systems and other critical systems. Examples according to the disclosed technology offer capability to form a holistic correlation between the technical components and management requirements.

Critical infrastructure increasing relies on network to computer technology. Thus, it is desirable to secure the supply chain of critical components such infrastructure systems such as electrical created control systems. However, there is currently a lack of available, quantifiable, and repeatable techniques to evaluate the cybersecurity of infrastructure systems including energy delivery systems. Further, desirable to provide secure integration between the electrical grid and the cybersecurity frameworks of connected building components.

In certain examples, a framework solution is provided by developing an easy-to-use framework with a graphical front end, and a process for assessing secure design and development of IT/OT (information technology/operational technology), so that cybersecurity best practices can be adopted, and processes can be assessed against desired cybersecurity maturity levels to produce more secure products. Disclosed methods can be applied to the lifecycles of software, firmware, hardware, and to human factors (e.g., training and environments for such computing systems).

In some examples, a graphical interface toolset allows a user to select the subset of the best practices for identification, selection, and remediation. For example, the user can use the graphical user interface (GUI) of the application to evaluate the computing environment's maturity in the areas of interest. For example, an EDS developer could choose to explore areas involving design and creation of devices and systems and an owner/operator might choose the areas involving use, maintenance, and end-of-life tasks. For an initial investigation, results might be compared to the expectations of upper management; later results could show growth from the initial baseline.

In some examples, these practices can be realized through the toolset using a GUI that allows the user to define the managerial requirements coupled with technical assessments. This allows the user to perform in-depth analysis of the results acquired from the assessment. Thus, disclosed computing systems allow correlation of management priority data indicating prescribed maturity levels (e.g., management priorities) with technical assessment data indicating expected maturity levels (e.g., technical and security controls). In some examples, a management user can select both an anticipated and a prescribed MIL level for every domain, subdomain, and/or sub-subdomain. The anticipated MIL level describes what management user expects the current MIL level of a respective project domain, subdomain, and/or sub-subdomain to be. The prescribed MIL level describes what a management user specifies as a desired or goal level for the respective project domain, subdomain, and/or sub-subdomain/

Certain examples of the disclosed technology can be used for one or more practical applications. For example, in some examples, an integrated tool allows management to determine desired maturity levels in a plurality of domains (e.g., from one to seven, or more, domains) to allow hardware and software designers to assess the maturity level of their design and development processes, and allows developers to monitor process maturity improvements against management goals. The tool can be used by commercial developers as well as internal development organizations.

In some examples, a holistic feedback-driven process and framework is provided that system designers and integrators of critical IT/OT infrastructure can use to assess and improve their design and development practices and procedures based on a set of best practices. By facilitating implementation of cybersecurity best practices, disclosed technologies can be used to compare the maturity levels against a set of management-derived requirements to determine the areas of interest where improvements can be made.

In certain described embodiments, disclosed methods and apparatus facilitate the secure development process through seven major domains covering Background & Foundation, Design, Build, Test, Integrate, Deploy, and Lifecycle & End-of-Life. As will be readily understood to one of ordinary skill in the relevant are having the benefit of the present disclosure, in other examples, different domains can be used to implement certain disclosed techniques, in accordance with the disclosed technology. These domains are generally implemented chronologically, but a domain can be revisited later in the development process, if necessary. For example, if serious errors are found during Test domain operations, it may be desirable to revisit the Build process; or, if new features are requested during Deploy domain processes, a major product revision may entail going all the way back to operations associated with the Background & Foundation domain to develop a new set of requirements to be designed, built, and tested.

Security gaps, management priorities, and recommended configuration changes to address identified security gaps in management priorities are produced at the end of an assessment. These recommended configuration changes can be implemented by members of a software development team, or automatically implemented using appropriately-configured software development tools. Thus, software designers and integrators can perform a timeboxed comparative analysis not only at technical level but also at managerial level. This feature helps the operators to determine where improvements have been made, and whether the improvements have caused an increase in the maturity level indicator for those improvements.

By developing an easy-to-use framework with a graphical front end, and a process for assessing secure design and development of IT/OT, cybersecurity best practices can be adopted, and processes can be assessed against desired cybersecurity maturity levels to produce more secure products. Identified best practices can be applied to the lifecycles of software, firmware, hardware, and to human factors (e.g., user training and environments). This data can be used to create a graphical interface toolset that allows a user to select the subset of the best practices. The user can use the graphical user interface (GUI) of a software application to evaluate the organization's maturity in the areas of interest. For example, an EDS vendor could choose to explore areas involving design and creation of devices and systems and an owner/operator might choose the areas involving use, maintenance, and end-of-life tasks. For an initial investigation, results might be compared to the expectations of upper management; later results could show growth from the initial baseline. Those best practices can be realized through disclosed toolsets using a GUI that allows users to define the managerial requirements coupled with technical assessments. This allows the user to perform in-depth analysis of the results acquired from the assessment.

### III. Example Computing Environment

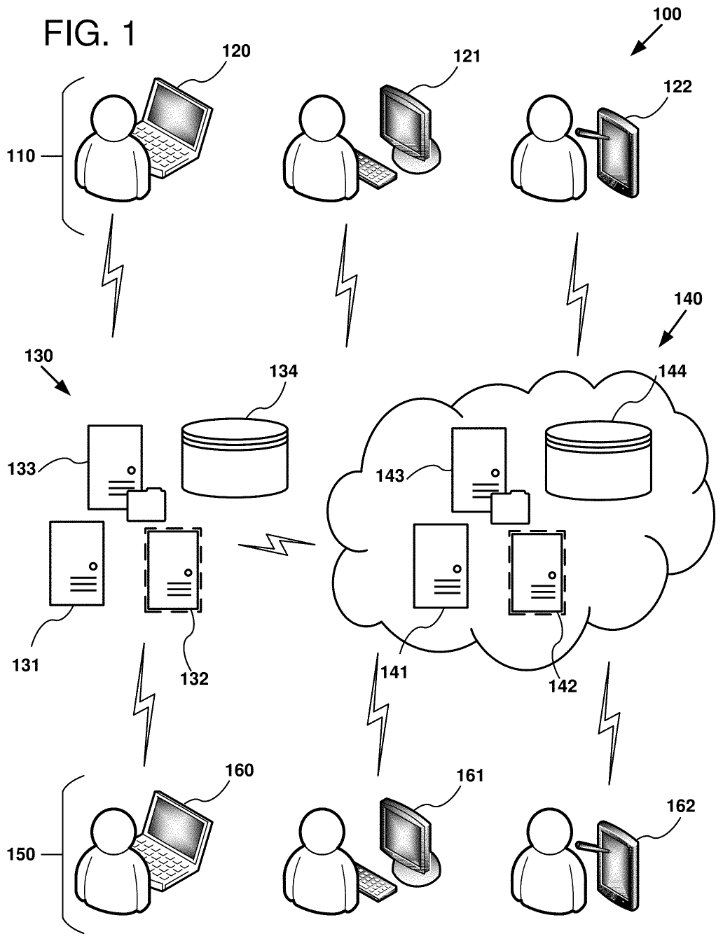

FIG. 1 illustrates a block diagram of an example computing environment 100 in which certain aspects of the disclosed technology can be implemented. As shown in FIG. 1 a number of managerial role users 110 are provided with computing devices, including laptop devices 120, desktop workstations 121, and tablet devices 122. These devices 120-122 are connected to a set of computing resources 130 via a computer network 129. These devices can accept input using any suitable technique, including keyboard, mouse, voice, and tactile input, and can further provide a graphical display including a graphical user interface using, for example, monitors connected to their computing devices via a wired or wireless interface or hard output via printer, plotters, or other suitable hard copy devices.

The computer network can implement any suitable wired or wireless communication technology for connecting the devices to the compute resources 130. In some examples, the compute resources can include any suitable combination of physical servers 131, virtual servers 132, file servers 133, and database servers 134 connected via a local area network (LAN) or wide area network (WAN). In some examples, the compute resources can include any suitable combination of cloud computing resources 140, including physical servers 141, virtual servers 142, file servers 143, and database servers 144 provisioned by a third party in a private or public cloud environment.

Further, a number of software developers, administrators, and other users can connect to the computing resources 130 or cloud computing resources 140 via similar forms of computer networks. For example, developers or administrators 150 can use any suitable computing devices, including laptop devices 160, desktop workstations 161, and tablet devices 162. These devices can accept input using any suitable technique, including keyboard, mouse, voice, and tactile input, and can further provide a graphical display including a graphical user interface using, for example, monitors connected to their computing devices via a wired or wireless interface or hard output via printer, plotters, or other suitable hard copy devices.

### IV. Example Method of Producing Configuration Changes

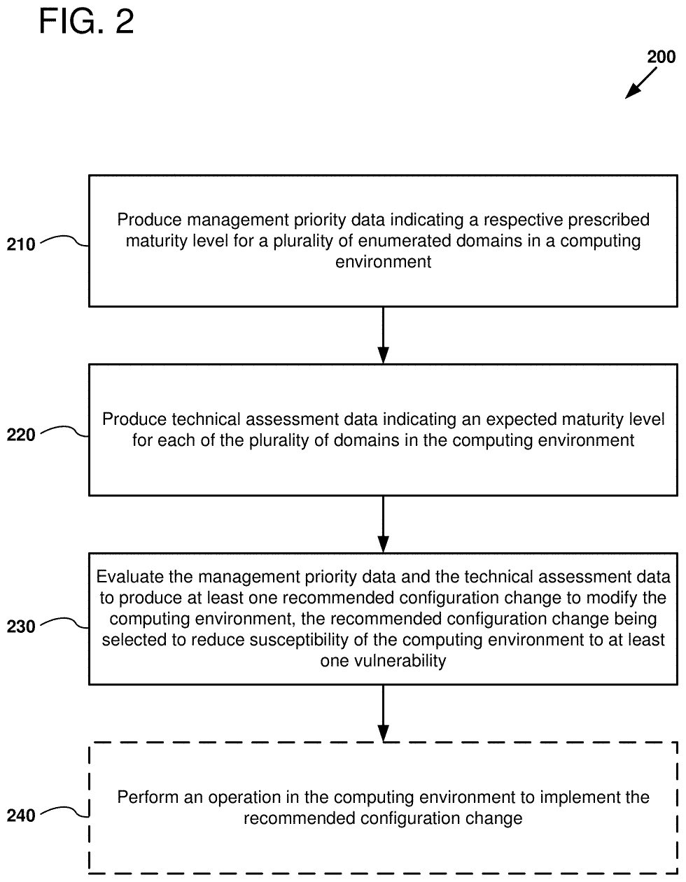

FIG. 2 is a flow chart 200 outlining an example method of producing recommended configuration changes for mitigating vulnerabilities in a computing environment, as can be implemented in certain examples of the disclosed technology. Any of the disclosed computing hardware and software can be used to implement the illustrated method.

At process block 210, management priority data is produced indicating respective prescribed maturity level for a plurality of enumerated domains in the computing environment. For example, graphical user interface can be used to allow user to select a desired maturity levels prescribed for a plurality of two or more domains defined for the computing environment.

At process block 220, technical assessment data is produced that indicates an expected maturity level for each of the plurality domain to the computing environment. For example, graphical user interface tool can provide a questionnaire receives user input on various elements of the computing environment and that data can be mapped back to the prescribed maturity levels that were produced at process block 210. In some examples, all or some of the expected maturity levels for all or some of the plurality of the domains can be produced automatically, for example by analyzing computing objects within the computing environment to determine aspects of the maturity levels. In some examples, the questions and answers can be stored in a JSON file or other file having a suitable format that indicates domains, subdomains, and sub-subdomains associated with particular questions provided for the technical assessment.

At process block 230, the management priority data and the technical assessment data is evaluated to produce at least one recommended configuration change for modifying the computing environment. The recommended configuration changes are selected to reduce susceptibility the computing environment to at least one of vulnerability. For example, a tool can provide recommendations on encoding techniques, configuration of competing elements, or other suitable configuration changes to be implemented in the computing environment in order to reach a higher maturity level.

In some examples of the disclosed technology, the data can be evaluated as follows. In order to achieve a specific MIL level for a given domain, all practices specified for the particular MIL-domain combination must be implemented. Further, the requirements of all lower-level MILs for the respective domain must be implemented as well. For example, in order to achieve MIL1 in a domain having for specified MIL1 practices, all four of the MIL1 practices must be implemented. In order to achieve MIL2 for the same domain, all MIL1 and MIL2 practices specified for the domain must be implemented. For evaluating subdomains and sub-subdomains, similar criteria can be used to determine whether a particular MIL level is achieved. In particular, for a given domain to achieve a particular level, all of its sub-domain's must satisfy the criteria for their respective MIL levels. If sub-subdomains are used, then all of the sub-subdomains defined under a subdomain hierarchy must meet a particular MIL level for the sub-domain to achieve that MIL level. A relationship matrix or hierarchy from a file describing queries for the technical assessment, for example, a JSON file as described above regarding process block 220 can be used to calculate MIL levels for each domain, subdomain, and/or sub-subdomain, as applicable to a particular example.

At optional process block 240, and operation is performed in the computing environment to implemented the recommended configuration change. Thus, the computing environment can be automatically updated according to one or more desired recommendations produced at process block 230.

### V. Further Detailed Method of Producing Configuration Changes

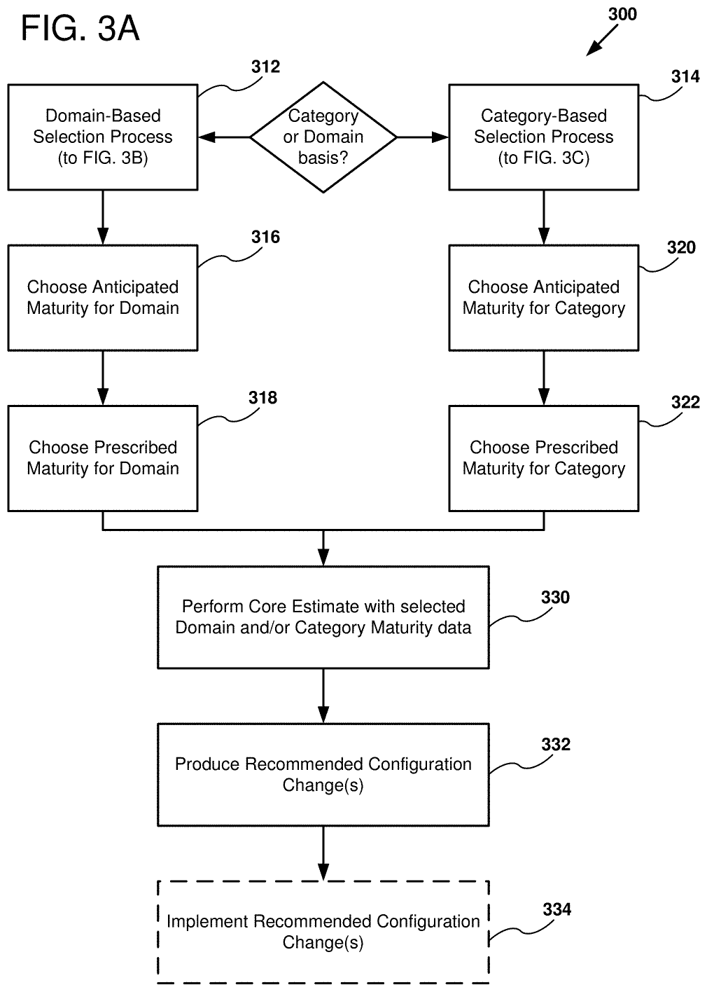

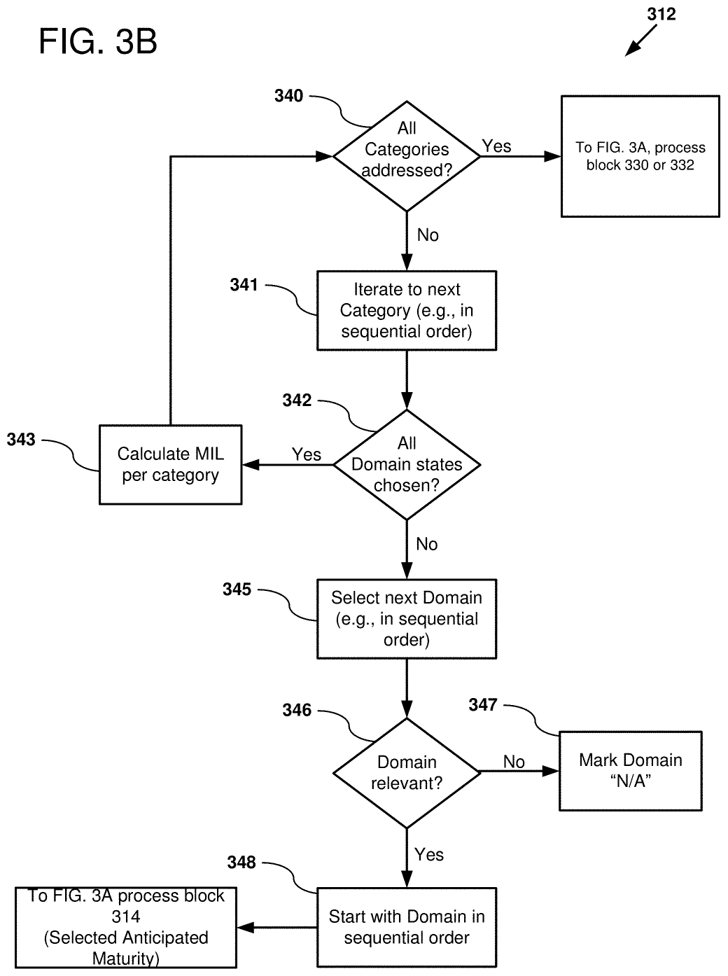

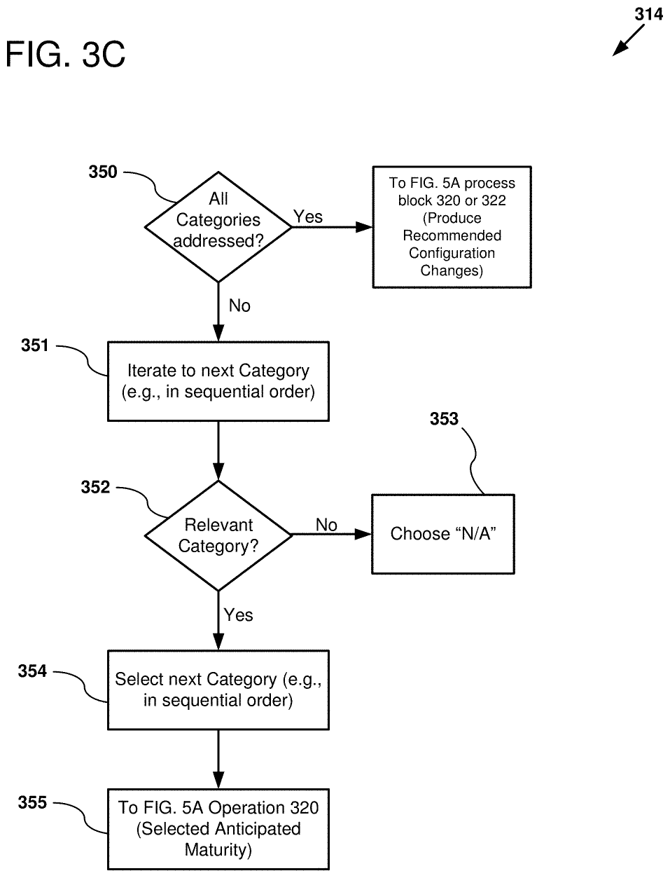

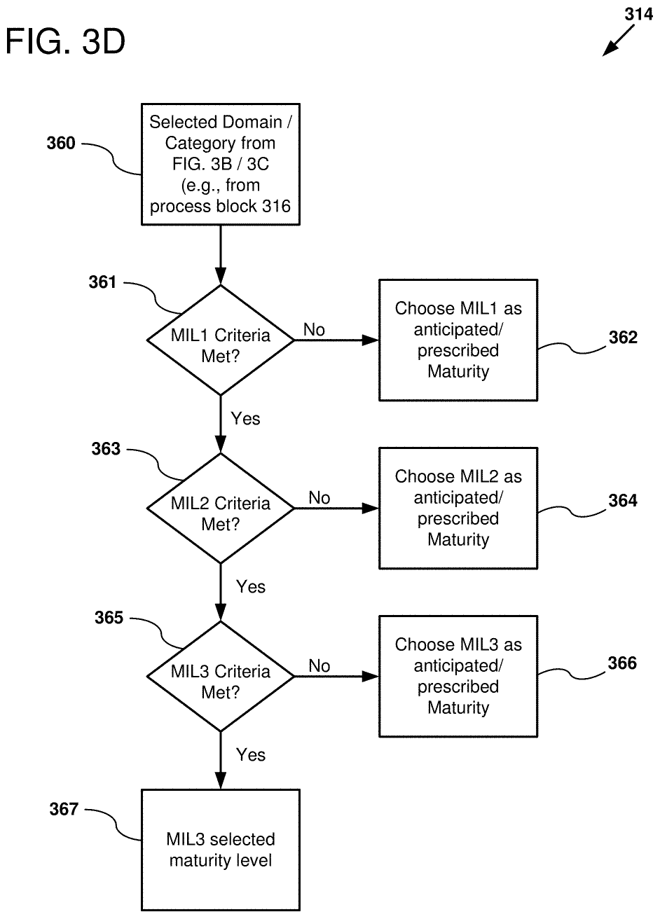

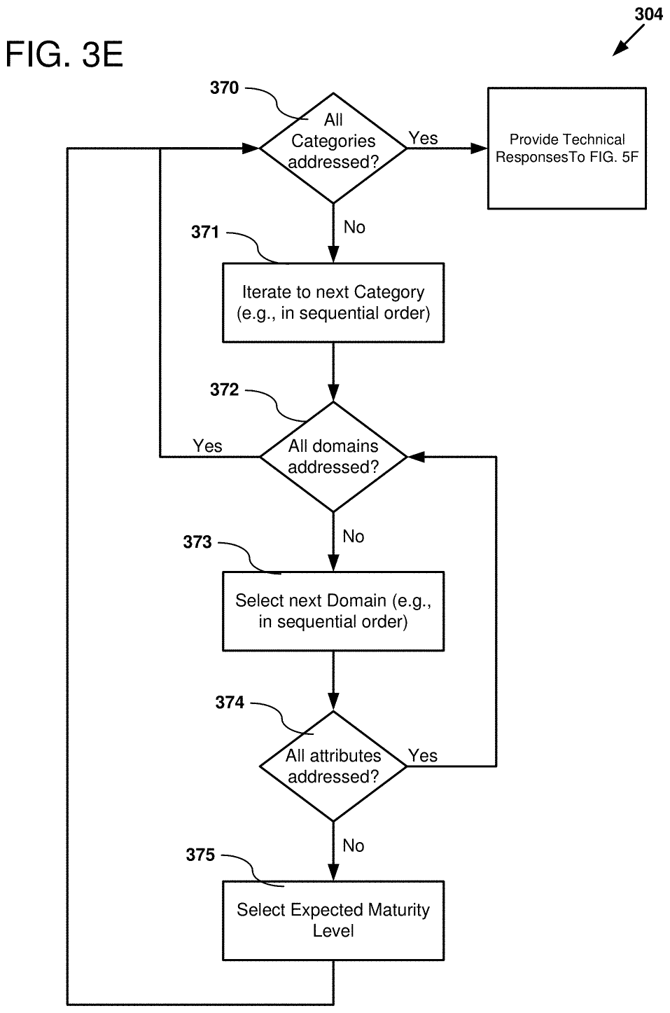

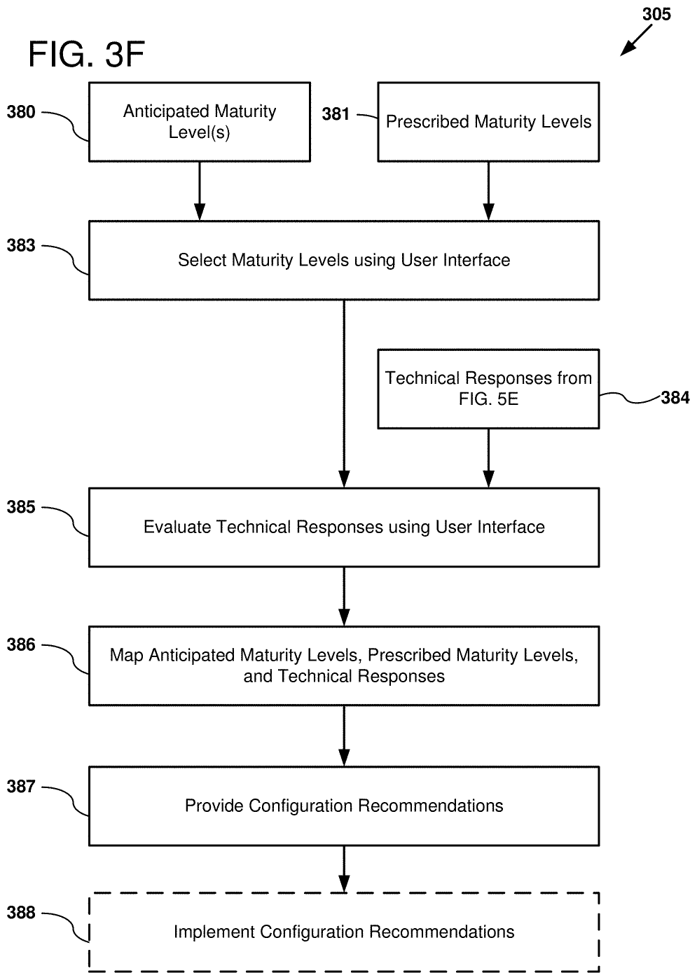

FIGS. 3A-3F illustrate a flow chart 300 outlining a further detailed example method of producing recommended configuration changes for mitigating vulnerabilities in a computing environment, as can be implemented in certain examples of the disclosed technology.

As shown in FIG. 3A, at process block 310 it is determined whether maturities are being selected on a category or a domain basis. If maturities are being selected in a domain base selection process, then the method proceeds to process block 312, but if the maturities are selected using a category base selection process, then the method proceeds to process block 314.

After proceeding through the domain base selection process at process block 312, an anticipated maturity is selected for the domain at process block 316. Then, a prescribed maturity is selected for the domain at process block 318. On the other hand, if a category based selection process was used at process block 314, the method proceeds to process block 320 to choose anticipated maturity levels for each category, and then to process block 322 to choose prescribed maturities for each selected category.

Regardless of whether a domain based or category based selection process was employed, the method proceeds to process block 330 where a core estimate is performed with the selected domain and/or category maturity data. At process block 332, recommendations for changes in configurations are produced based on the core estimate, the domain data, and/or the category maturity data. At optional process block 334, recommended configuration changes are implemented based on the recommended changes produced at process block 332.

As used herein, anticipated maturity levels refer to a MIL level or other maturity level that is anticipated to be completed at a particular point or period of time. In contrast, a prescribed maturity level refers to a desired maturity level, for example, that a manager selects for project developers to drive progress towards. Further, as used herein, an expected maturity level is derived from developer input in response to technical queries that indicates the actual status of progress towards goals from a bottom-up perspective. The anticipated or prescribed maturity levels can be thought of as top-down direction provided to developers or administrators.

In some examples of the disclosed technology, the data can be evaluated as follows. In order to achieve a specific MIL level for a given domain, all practices specified for the particular MIL-domain combination must be implemented. Further, the requirements of all lower-level MILs for the respective domain must be implemented as well. For example, in order to achieve MIL1 in a domain having for specified MIL1 practices, all four of the MIL1 practices must be implemented. In order to achieve MIL2 for the same domain, all MIL1 and MIL2 practices specified for the domain must be implemented. For evaluating subdomains and sub-sub domains, similar criteria can be used to determine whether a particular MIL level is achieved. In particular, for a given domain to achieve a particular level, all of its sub-domain's must satisfy the criteria for their respective MIL levels. If sub-subdomains are used, then all of the sub-subdomains defined under a subdomain hierarchy must meet a particular MIL level for the sub-domain to achieve that MIL level.

Operations that occur at process block 312 are further detailed in FIG. 3B. As shown, first it is determined 340 whether all categories have been addressed. If all categories have been addressed, the method proceeds back to process block 330 or 332. If there are additional categories to be addressed, the method proceeds to process block 341 in order to iterate to the next category. For example, the next category can be selected according to sequential order, although any suitable method of choosing the next category can be used. At process block 342, determine whether all domain states have been chosen. If all the domain states have been chosen, the method proceeds to process block 343, where it calculates MIL on a per category basis and returns to 340 to determine whether there are additional categories to be addressed. If not all domain states have been chosen, the method proceeds to process block 345 where the next domain is selected. For example, the next domain can be selected according to a sequential order, although any suitable method of choosing the next domain can be used. At process block 346, determine whether the domain is relevant to the associated selected category. If the domain is not relevant, the domain is marked as not applicable at process block 347. If the domain is relevant, the method starts with the selected next domain at process block 348 and proceeds to process block 314 to choose the anticipated maturity for the domain as discussed in further detail above.

Operations that occur at process block 3140 further detailed in FIG. 3C. As shown, first it is determined 350 whether all categories have been addressed. If all categories have been addressed, the method proceeds back to process block 320 or 322. If there are additional categories to be addressed, the method proceeds to process block 351 in order to iterate to the next category. For example, the next category can be selected according to sequential order, although any suitable method of choosing next category can be used. At process block 352, it is determined whether the current category is relevant. If the current category is not relevant, the method proceeds to mark the category as not applicable at 353. If the current category is determined to be relevant, the method proceeds to process block 354 in order to select the next category. For example, the next category can selected according to a sequential order, although any suitable method choosing the next category can be used. At process block 355, the method proceeds to process block 320 in order to select the anticipated maturity level.

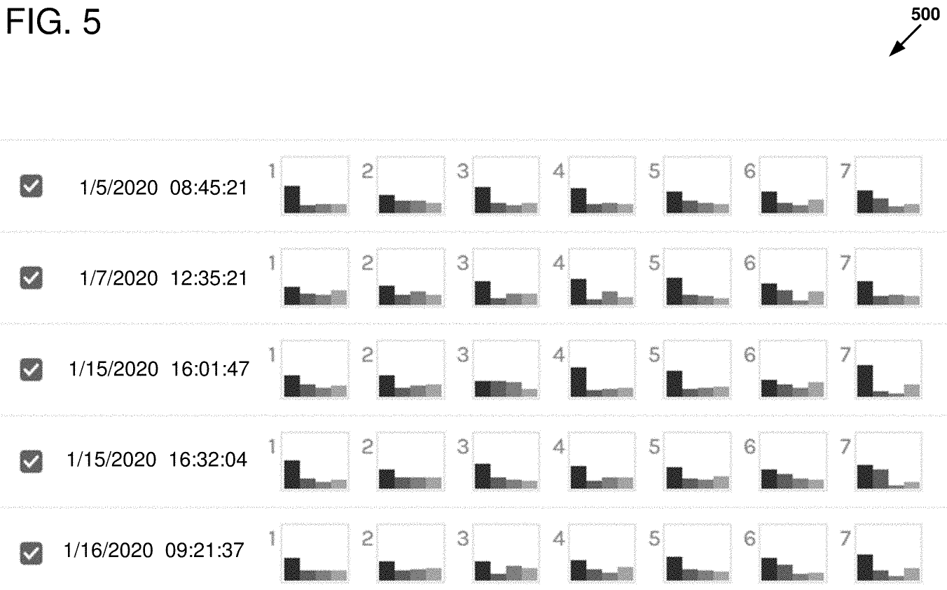

Turning to FIG. 5D, operations that are performed at process block 316 are described in further detail. As will be readily understood to one of ordinary skill in the relevant art having the benefit of the present disclosure, the operations outlined in FIG. 5D can be readily adapted to perform similar operations as discussed above regarding process blocks 318, 320, and 322.

At process block 360, a selected domain or category received from one of process blocks 316, 318, 320, or 322. At 361, it is determined whether the MIL1 criteria have been met. If the criteria have not been met, the method proceeds to process block 362 and MIL1 is selected as the anticipated or prescribed maturity level. If MIL1 criteria are met, the method proceeds to process block 363 and it is determined whether the MIL2 criteria have been met. If the criteria have not been met, then the method proceeds to process block 364, and MIL2 is selected as the anticipated or prescribed maturity level. If the MIL2 criteria are met, method proceeds to process block 365, and is determined whether the MIL3 criteria have been met. If the criteria have not been met, then the method proceeds to process block 366, and MIL3 is selected as the anticipated or prescribed maturity level. If the MIL3 criteria are met, method proceeds to process block 367, and MIL3 becomes the selected maturity level.

Turning to FIG. 3E, operations that are performed at process block 330 are described in further detail. At process block 370, it is determined whether all the categories have been addressed. If so, then technical responses are provided to process block 384. if there are additional categories to address, the method proceeds to process block 371, where the method iterates to the next category, for example according to a sequential order. At process block 372, it is determined whether all mates a been addressed, and if so the method proceeds back to process block 370. If there are additional of domains to address, that they next dating is selected, for example, according to a sequential order at process block 373. At process block 374, is determined whether all attributes have been addressed. If so, the method proceeds to process block 372. If all attributes have not been addressed, then an expected maturity level is selected for the domain/category combination at process block 375, and the method proceeds back to process block 370.

Turning to FIG. 5F, anticipated maturity levels selected at process blocks 316 and/or 320 are received at process block 380. At process block 381, prescribed maturity levels, from process blocks 318 and/or 322 are received. At process block 383, maturity levels are selected by a user using, for example a graphical user interface provided by a computer is discussed in further detail below. At process block 384, technical responses are received. At process block 35, technical responses are evaluated using a user interface, for example a graphical user interface provided by a computer coupled to a display. At process block 386, anticipated maturity levels, prescribed maturity levels, and technical responses are mapped. Thus, different his between anticipated and prescribed maturity levels from management can be reconciled with technical responses from engineers or software developers indicating the current state of a hardware or software project. At process block 387, configuration recommendations are provided based on the mapping performed at process block 386. For example, changes in configuration or methodology can be recommended as discussed above regarding process block 332. At process block 388, configuration recommendations are implemented, as discussed in further detail above regarding process block 334. In some examples, the recommendations are automatically appointed, while in others, output is provided to a developer in order to implement further changes in the system.

As will be readily understood to one of ordinary skill in the relevant art having the benefit of the present disclosure, the operations outlined at FIGS. 3A-3F can be computed numerous times as progress on a software or hardware development project proceeds, thereby obtaining updated levels of maturity as progress is made.

### VI. Example Implementation of Domains and Maturity Indicator Levels

### A. Example Domain Descriptions

The seven domains used by the SD2-C2M2 tool follow the typical hardware or software design lifecycle. As used herein, the term “domain” refers to a collection of data associated with an enumerated stage of software development or deployment. Domains (for example, the example domains described below) allow disclosed applications to logically group the best practices and allow responses to be given by different subject matter expert groups.

Background & Foundation: This domain considers practices and procedures that serve as foundation processes. Examples of software development that can be addressed by this domain include developer training; understanding the environments in which the products will or could be deployed; processes for gathering and documenting requirements in accordance with which the products will be designed, built, and tested; understanding and using the tools that the developers will be using, and understanding the security considerations of working with third-party suppliers and vendors.

Design: This domain considers the processes used to specify how products will be built, based on requirements and other factors. In addition to hardware and software design considerations, these factors include human factors (e.g., usability), failure mode analysis, selection of programming languages, system (as opposed to component) design, security considerations, and designing for testability and maintenance of the final product.

Build: This domain considers practices that are used to turn the design into a product that can be delivered to customers. These practices include hardware construction and software development, as well as managing changes, and considering the impacts of third-party suppliers.

Test: This domain considers the processes used to test the developed and built products against the specified requirements. The Test domain considers testing of the hardware and software components.

Integrate: This domain considers the processes used to integrate hardware and software components into a system. These processes and procedures include integration and assembly procedures, configuration actions performed at the factory, system-level testing, customer-witnessed factory testing, and preparing the system for shipment to the customer.

Deploy: This domain considers the processes and procedures used by the customer to configure and use the delivered system. These processes and procedures include additional testing of the system in its ultimate location, training of the customer in the use of the system, and using the documentation provided to the customer with the system.

Lifecycle & End-of-Life: This domain considers the processes used by the customer to operate and maintain the delivered system. Maintenance procedures include customer-performed as well as factory-performed maintenance. The domain also includes end-of-life actions to dispose of the system and information contained in it when the system is no longer in service.

### B. Example Maturity Descriptions

Disclosed methods and apparatus are used to assess practices and procedures used for secure design and development of systems. The technology can be used to assess a software project and determine whether procedures and processes exist and determine their level of formality. A user interface can be used to elicit four enumerated states of implementation:

Not Implemented: The respective practice or procedure has not been implemented.

Informally Implemented: The respective practice or procedure is implemented, but not in a formal or consistent manner. Developers may be aware of the practice or procedure and may implement it at varying levels. No oversight exists to determine whether the practice is being performed. Processes may be implemented in an ad hoc manner based on “tribal knowledge base” or suggested by senior designers/mentors.

Documented: A respective practice or procedure is documented with expectations by management that it be followed, but it is not necessarily being followed. If it is followed, it may not be followed completely or consistently across projects or between developers. There are no procedures in place to determine whether the procedure is being followed.

Formally Implemented: The respective practices/procedures are being consistently followed as documented in all cases. Oversight is in place (e.g., automated reviews, peer reviews, sign-off, supervisory oversight) to ensure that the procedure is being followed, and that deviations from expected performance are corrected. Procedures may be reviewed periodically to determine whether improvements can or need to be made to them.

For example, in the Background & Foundation domain, for the Developer Training & Certification subdomain, the following implementation states could be applied:

Not Implemented: No training is expected or required.

Informally Implemented: Tribal or institutional knowledge—for example, in source code comments.

Documented: Coding procedures are implemented but with no follow-on that determines whether they are implemented, no training other than “here is the document—follow it.”

Formally Implemented: Classroom training (e.g., for a predetermined amount of time, for example, 4 to 8 hours), with refresher training, code review sign-off looking for specific coding errors, and an automated code inspection tool.

Disclosed apparatus and methods can also be used to determine the efficacy of procedures used on a specific project. For example, if formal procedures exist for an area, but they are not followed during the development of a particular product (for example, because they are outdated, create perceived inefficiencies, or are deemed unimportant by line management or supervisors), the lack of conformance with the procedures indicates a gap in the implementation of the procedures, not necessarily a shortcoming of the procedures themselves. Conformance with the established procedures needs to be investigated to determine the root cause of the gap and a remedy to address the gap (for example, to modify the procedures to make them relevant or efficient, or to address supervisory attention to the documented procedures).

### C. Example Maturity Level Indicator (MIL) Descriptions

The Maturity Indicator Level (MIL) descriptions are indicators of the maturity of a software project with respect to an associated domain. MILs can include one or more of the following four aspects:

1. MILs apply independently to each domain. As a result, an organization using the model may be operating at different MIL ratings for different domains. For example, an organization could be operating at MIL1 in one domain, MIL2 in another domain, and MIL3 in a third domain. In one particular example, MIL1 is used to indicate initial practices that may be performed in an ad hoc manner. The next level, MIL2, in the case of the practices are documented, stakeholders are involved, an adequate resources have been provided and used developed the system. MIL3 indicates that procedures and systems have been formally implemented and reviewed.

2. The MILs are cumulative within each domain. To earn a MIL in a given domain, an organization must perform all of the practices in that level and its predecessor level(s). For example, an organization must perform all of the domain practices in MIL1 and MIL2 to achieve MIL2 in the domain. Similarly, the organization would have to perform all practices in MIL1, MIL2, and MIL3 to achieve MIL3.

3. Establishing a target MIL for each domain is an effective strategy for using the model to guide cybersecurity program improvement. Organizations should become familiar with the practices in the model prior to determining target MILs. Gap analysis activities and improvement efforts should then focus on achieving those target levels.

4. The performance of best practices and MIL achievement should be aligned with business objectives and the organization's cybersecurity strategy. Striving to achieve the highest MIL in all domains may not be optimal. Organizations should evaluate the costs of achieving a specific MIL against potential benefits. However, the MIL model disclosed in the detailed examples herein was developed so that all companies, regardless of size, should be able to achieve MIL1 across all domains.

### D. Example Software Application, Design, and User Interface

Software tools implemented according to the disclosed methods and apparatus can include a number of different functionalities. Design features of suitable tools can include a pie summary, timeline graphs, and tabular plots; a save/load feature can be used to retain assessment on-premises; and the ability to generate a reports (e.g., in Adobe Portable Document Format (PDF) at the end of an assessment. This section will introduce examples of these features in detail.

1. Software Design and Features

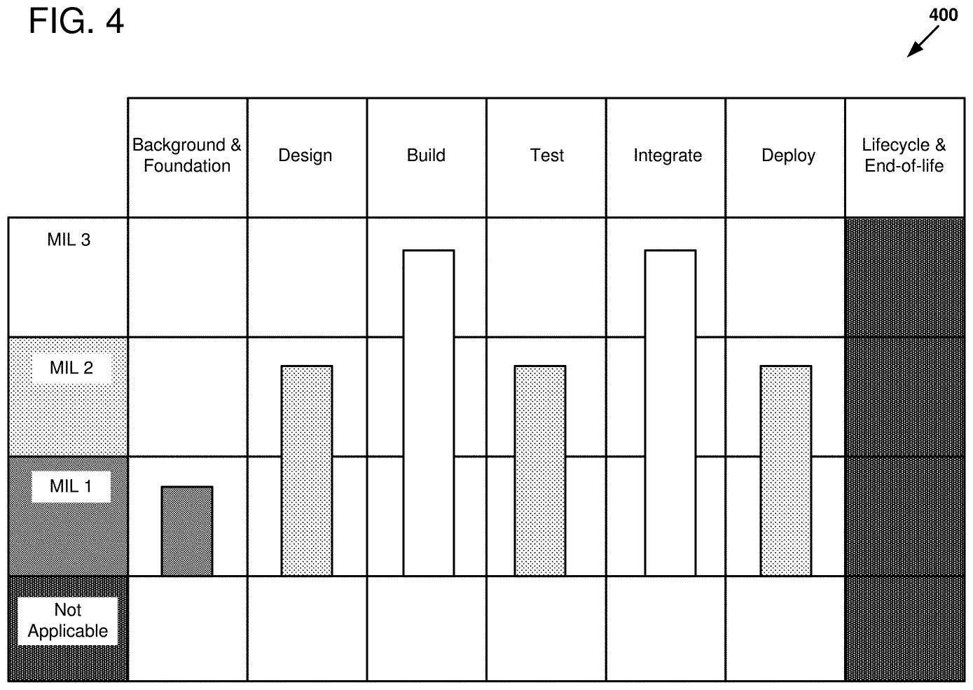

Management Priorities: An example management priorities sub-application allows management to define their goals across all the domains. An illustration of such a sub-application is shown in a user interface display 400 in FIG. 4. As shown, management expects to reach MIL1 for the Background & Foundation domain; MIL2 for the Design, Test, and Deploy domains; and MIL3 for the Build domain and the Integrate domain. During the core assessment process, the management priorities will be reflected in the process. Therefore, this sub-application acts like a bridge between management expectations and the practices of engineering and development teams.

Core Application. A Core application can include a large number of best practices (for example, more than 700 best practices) related to secure design and development processes that are tailored to technical and non-technical/management aspects of an organization. The best practices are divided and grouped over seven domains that are further divided into 35 subdomains. The Core application can provide a framework questionnaire with a computer-implemented graphical user interface to gather input regarding anticipated and prescribed maturity levels for the respective domains.

Comparative Evaluation Application: Estimating the progress of adopting best practices is not trivial, especially when the process involves a comparison of more than 700 best practices. Therefore, the comparative evaluation sub-application can be used to automate comparison between various assessments from previous and the current assessment. This sub-application has built-in data analytics to provide extensive analysis of the findings. An illustrative comparison of five assessments, as can be presented to a computer system user with a graphical user interface 500, is shown in FIG. 5. As shown, the varying levels of anticipated or prescribed maturity levels for the various domains varies as the project progresses based on user input.

Other Software Features: including the following: Additional features can be implemented in certain examples of disclosed software applications, including the following features:

Cached Progress: Responses to assessment questions are saved in the browser cache. The user can use this feature to complete the assessment over multiple sessions instead of doing it in one sitting.

Load/Save Progress: The assessment progress can be saved to a file, which facilitates comparison over time. In a medium to large organization, software and hardware design processes are often spread across multiple teams. This feature will let the users finish their portion of the assessment and share it with the other teams to complete the remaining portion of the assessment. The teams are not forced to do the assessment together, which may be impractical to expect in a large organization. The load feature lets the users download the assessment, which can also be used in the comparative evaluation sub-application.

Export Report: During or at the end of an assessment, the application generates a report with interactive graphics and data visualizations in the web portal. The report can also be exported in any suitable format (for example, as a PDF file, eXtensible Markup Language (XML), HTML, or other suitable file format) file for portability and archiving. The HTML version of the report can be dynamic and interactive and allow the user navigate between the results and various sub-tools on the fly.

2. Example Data Visualizations

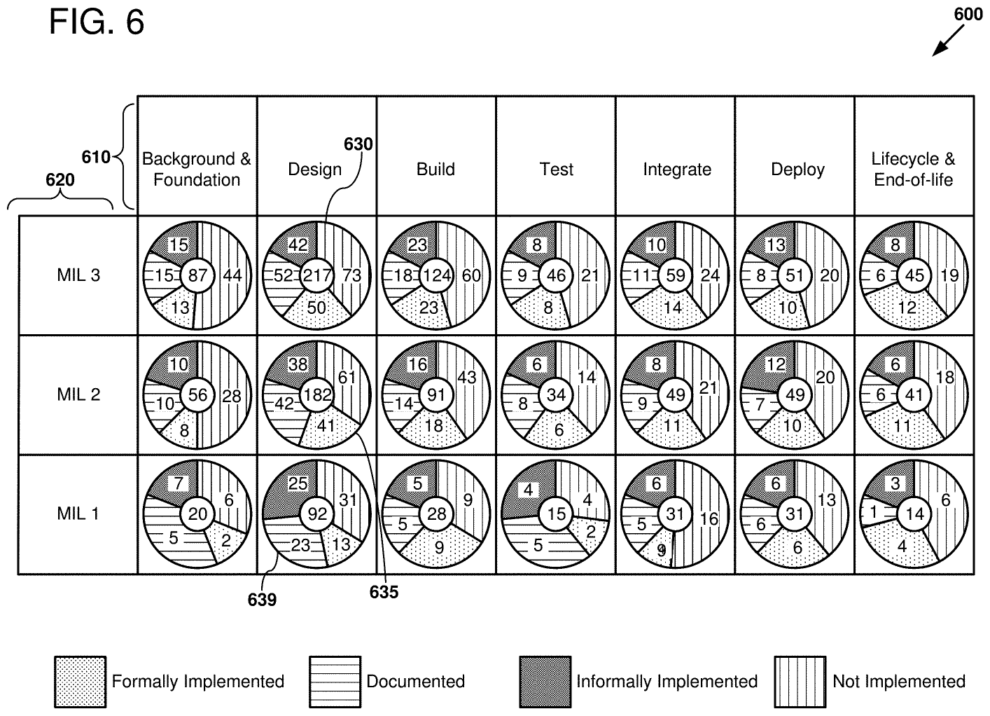

Pie Summary: FIG. 6 shows an example of a pie summary 600 that provides a brief overview of the evaluation results. The pie summary 600 can be displayed using a graphical user interface or other computer display, as a graphical representation in a stored report file, or in any other suitable format. As shown in the example of FIG. 6, the pies are organized by domain 610 and MIL 620. In the illustrated example, the pie summary is depicted as follows: the MIL1 pie includes a depiction of responses to MIL1 questions; the MIL2 pie includes the responses to both MIL1 and MIL2 questions; and the MIL3 pie includes the responses to MIL1, MIL2, and MIL3 questions.

As a detailed example of a pie instance, consider the MIL3 Design domain pie 630. This pie represents responses provided by developers and/or by an automatic assessment tool relative to the associated MIL for levels defined for the domain. As shown, of the criteria established for the Design domain, the project currently has 73 unimplemented aspects, 50 informally implemented aspects, 52 documented (and informally implemented) aspects, and 42 formally implemented aspects for the Design domain, MIL3 domain pie 630. The relative proportion of each pie edge corresponds to the number of satisfied criteria at each respective level. Further, the domain pie 630 shows that 217 total criteria have been evaluated. As shown, a numerical representation of the satisfied criteria are also display on the domain pie 630. It should be readily understood to one of ordinary skill in the relevant art that the higher MIL levels include criteria for associated lower MIL levels. For example, MIL3 Design domain pie 630 includes the cumulative criteria for MIL2 (as represented by domain pie 635) and MIL1 (as represented by domain pie 639). The example application can also generate an alternate version of the pie summary 600 that does not combine lower MILs (independent pie summaries).

In some examples MIL1 indicates that the initial practices performed may be in ad hoc manner; MIL2 indicates that the practices are documented, stakeholders are involved, and adequate resources are provided and used; MIL3 indicates that the procedures and systems are reviewed in conformance and are guided with policies. MIL3 also emphasizes strict access controls, roles, and responsibilities.

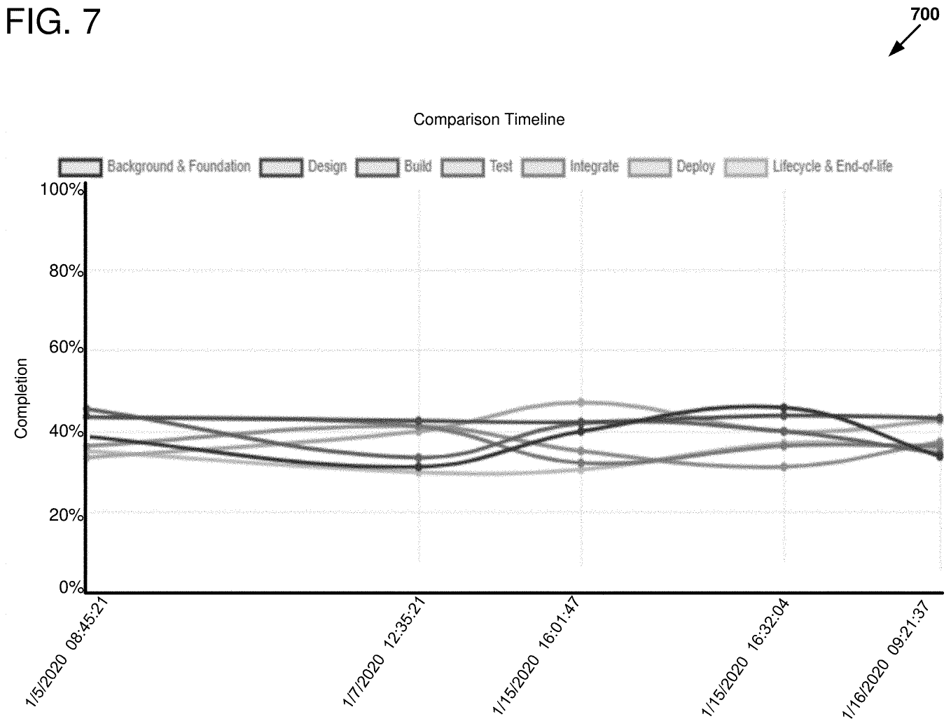

Example timeline graph and tabular plot: FIG. 7 shows a graph 700 that is generated from the comparative analysis application and can be displayed with a graphical user interface tool or saved in a report. When the user imports multiple assessment files, this sub-application generates two main visualizations: (1) a line plot shown in the graph 700 with a “total implementation” line of maturity of all domains (the Y-axis for this graph is “percentage implemented”; the X-axis is different points in time that the evaluation is associated with), and (2) a tabular bar chart plot that shows the overall differences between the loaded assessments, as shown in FIG. 5.

### VII. Example Case Study: Buffer Overflow Attack

This section provides a brief overview of the buffer overflow attack and demonstrates the efficacy of disclosed methods and apparatus by providing a case study demonstrating how a software development team can adopt practices to defend against buffer overflow attacks. This section begins with an enumeration of various Common Weakness Enumerations (CWE) that are related to buffer overflow attacks. Then, use of disclosed methods and apparatus to mitigate those CWEs is demonstrated.

### A. Buffer Overflow Attacks

Buffer overflows are one of the most common software vulnerabilities whose exploitation can result in a severe impact on the software program. An example of CWE enumerations is provided in Martin et al., 2011 CWE/SANS Top 25 Most Dangerous Software Errors, (MITRE 2011), which identifies three common weakness enumerations (CWEs) that are directly related to buffer overflow and are summarized below in Table 1.

TABLE 1

| CWE | Rank | Description | Consequence |
|---|---|---|---|
| 120 | 3 | Buffer copy | Unverified input leads |
| | | without checking | to buffer overflow that |
| | | size of input (classic | can cause the |
| | | buffer overflow | application to crash |
| | | | or put the program |
| | | | into an infinite loop. |
| 190 | 24 | Integer overflow | Wraparound results in |
| | | or wraparound | buffer overflow, which |
| | | | results in memory |
| | | | corruption and undefined |
| | | | behavior of the program. |
| 131 | 20 | Incorrect calculation | Incorrect calculation leads |
| | | of buffer size | to an out-of-bound read or |
| | | | write that results in an |
| | | | application crash or |
| | | | exposure of sensitive data. |
| 798 | 7 | Use of hard-coded | Loss of credentials can lead |
| | | credentials | to access to the software. |
| 129 | >25 | Improper validation | Untrusted array index leads |
| | | of array index | to potential modification |
| | | | of memory sequences. |
| 789 | >25 | Uncontrolled memory | Uncontrolled memory allocation |
| | | allocation | leads to out-of-memory issues |
| | | | and application crash. |
| 191 | >25 | Integer underflow | Trigger buffer overflow by |
| | | | executing arbitrary code. |
| 805 | >25 | Buffer access with | Incorrect length puts the |
| | | incorrect length | program in an infinite loop |
| | | | that leads to application |
| | | | crash. |
| 119 | >25 | Improper restriction of | Execute unauthorized code |
| | | operations within the | leads to buffer overflow. |
| | | bounds of a memory | |
| | | buffer | |

As shown in Table 1 above, it is evident that multiple CWEs are related to buffer overflows. Therefore, preventing buffer overflow attacks on an illustrative software system provides an illuminating illustration of one possible application of disclosed methods and apparatus. Thus, by preventing such attacks, multiple computing system vulnerabilities can be mitigated.

### B. Overview of a Buffer Overflow Attack

A buffer overflow attack places data in the buffer that is beyond the buffer's allocated size. This causes data to be unexpectedly overwritten into portions of memory not within the buffer's allocated memory, which can lead to a system crash or facilitating injection of malicious code by an attacker.

Based on a review of a buffer overflow attack, the following security gaps are identified: (1) input checking should be monitored and validated; (2) file access and user permissions should be kept in mind while programming; (3) password and authentication should not be hard-coded; (4) program code auditing practice should be mandatory, (5) during design, the data segment of buffer space should be placed in a non-executable zone; (6) patch updates should be mandatory; and (7) buffer size limitations should to be enforced

1. Attack Definition

A group of hypothetical adversaries called AttackBuffers excels at identifying the buffer overflow vulnerabilities in the hard drive of a computer system server located in an organization's facilities. The adversary group also excels at identifying the exact buffer size of the software program of that server and takes control of the buffer. AttackBuffers then creates a specially crafted save file and stores it on the hard drive. The buffer is overflowed by the save file causing the server to crash, potentially resulting in significant damage to the server, the computing environment, and the organization.

2. Illustrative new establishment: MIL0 Organization

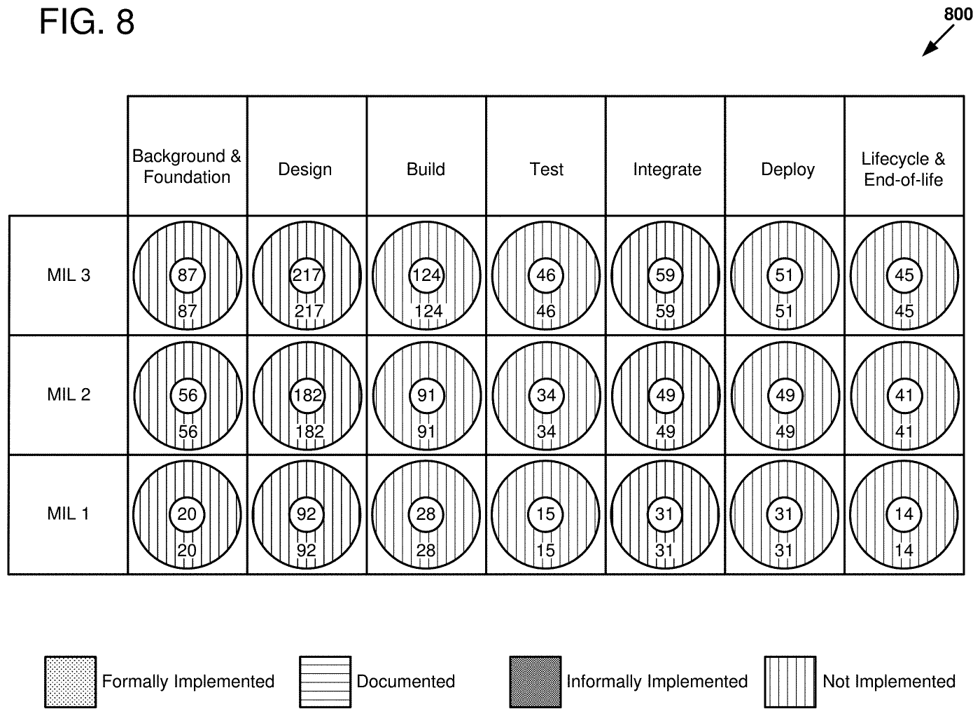

Initially, a hypothetical organization dubbed NewOrgSoft started at maturity level MIL0 with no best practices in place to defend against buffer overflow attacks. Therefore, the overall maturity of the organization looks like the illustration in FIG. 8. In this state, the NewOrgSoft is vulnerable to attacks from AttackBuffers. The cybersecurity team at NewOrgSoft made it an absolute priority to implement and improve the cybersecurity best practices progressively based on the timeline shown in Table 2. Throughout the next sections, all the best practices adopted to reach a particular MIL are discussed. Note that the CWEs shown in the previous section are evaluated throughout each maturity phase and are given one of the four ratings: Not Implemented (NI), Partially Implemented (PI), Documented (D), and Formally Implemented (FI). As shown in Table 3, none of the CWEs are addressed at MIL0 state.

TABLE 2
Cybersecurity improvement timeline

| Dates | Organization State | Target Maturity |
|---|---|---|
| D 1: m 1/dl/y 1 | Establishment | MIL0 |
| D 2: D 1 + 6 months | Basic Security | MIL1 |
| D 3: D 2 + 6 months | Medium Security | MIL2 |
| D 4: D 3 + 6 months | Advanced Security | MIL3 |

TABLE 3
CWE evaluation for MIL0 at date D 1

| CWE | Status |
|---|---|
| CWE-120 | NI |
| CWE-190 | NI |
| CWE-131 | NI |
| CWE-798 | NI |
| CWE-129 | NI |
| CWE-789 | NI |
| CWE-805 | NI |
| CWE-119 | NI |

3. MIL1 Best Practices Related to Buffer Overflow Attack

NewOrgSoft set a target to reach MIL1 before 6 months from the start of improvements (i.e., by date D2 in Table 2). Out of the more than 700 best practices, the following MIL1 best practices are related to buffer overflow. Therefore, the practice sets (PSs) should be fully implemented to have an efficient first line of defense against buffer overflow attacks and to achieve MIL1 status:

PS1: Software developers are required to undergo formal training for the relevant programming languages and security best practices.

PS2: A formal software functional and non-functional requirement gathering process that follows recognized standards should be enforced.

PS3: Vulnerability disclosure procedures and breach notification procedures should be in place and periodically updated.

PS4: With the focus on designing the software for integrity, the design process should include failure mode analysis and measures to handle out-of-bounds logical parameters.

PS5: All the software interfaces between the components should follow recognized standards and be formally documented. Software language selection should be considered during the design considering the requirement to ensure that the software is tolerant to input error.

PS6: The software should be designed with defense-in-depth concepts, and the testability of software components and the assembled system should be built into the design. Periodically, the software test libraries should be updated to reflect special cases and conditions that trigger “bug-fix” modifications.

PS7: For effective testing purposes, the software test plans and test libraries should include abnormal tests and test sets.

PS8: The software should be developed with coding techniques to validate the input.

PS9: Software testing procedures should include regression testing when the components are changed to confirm all problem reports preventing shipping have been resolved.

PS10: Site acceptance tests that include validation of the software should be conducted using customer data and environments. Problem report resolutions should be delivered at the end of applying and testing the site acceptance tests. All patches should be tested prior to software release to customers and customer documentation/guides should include instructions for reporting bugs.

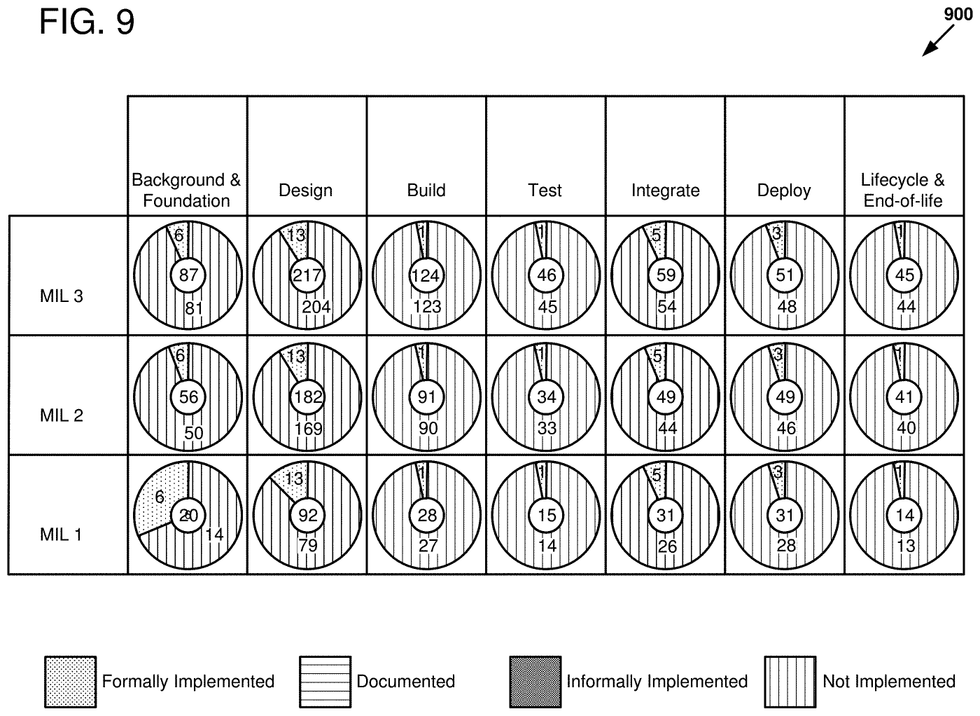

Upon achieving the FI (Formally Implemented) status for all the above-listed practice sets, the distribution and overall maturity is as shown in the graphical user interface display 900 of FIG. 9. As shown in FIG. 9, numbers in the portion of the pies (indicated by shading as Formally Implemented) are unchanged across MIL1, 2, and 3. This is because none of the MIL2 and MIL3 best practices are at state FI. Because MIL1 is a subset of MIL2 and MIL2 is a subset of MIL3, the number of best practices that are FI remains unchanged by date D2. Based on the maturity shown in FIG. 9, improvements across each domain are shown in Table 4, and the CWEs addressed because of the improvements are shown in Table 5. Note that the best practices that are FI are only related to buffer overflow attack. Therefore, in regard to buffer overflow attacks, NewOrgSoft is at MIL1. However, as shown in FIG. 9, not all best practices from MIL1 are FI. Therefore, the overall grade of NewOrgSoft is still MIL0.

TABLE 4
Cybersecurity improvements achieved by date D 2

| Domain | Total | FI | % Improve |
|---|---|---|---|
| Background and Foundation | 87 | 6 | ~7% |
| Design | 217 | 13 | ~6% |
| Build | 124 | 1 | ~0.9% |
| Test | 46 | 1 | ~2% |
| Integrate | 59 | 5 | ~0.7% |
| Deploy | 51 | 3 | ~6% |
| Lifecycle and End-of-Life | 45 | 1 | ~2% |

TABLE 5
CWE evaluation for MIL1 at date D 2

| CWE | Status | Related PS |
|---|---|---|
| CWE-120 | PI | 1, 5, 8 |
| CWE-190 | PI | 4, 5, 6, 8 |
| CWE-131 | D | 6, 8, 9 |
| CWE-798 | PI | 1, 4, 6 |
| CWE-129 | D | 5, 8 |
| CWE-789 | FI | 8 |
| CWE-805 | PI | 1, 5, 8 |
| CWE-119 | PI | 1, 5, 8 |

4. MIL2 Best Practices Related to Buffer Overflow Attack

By successfully reaching the target MIL1 state by date D2, NewOrgSoft set a new target to reach MIL2 before 6 months from the date D2 (i.e., by date D3 in Table 2). To achieve MIL2 with respect to buffer overflow attacks, in addition to the previously stated best practices, the following MIL2 practice sets must be satisfied to achieve the status of FI.

PS11: Software developers are required to undergo formal training on development tools, environments, and local development practices/tools. They should be trained in technical and secure coding concepts. The training topics should also include cybersecurity topics such as vulnerability analysis, programming language-based security, and source code analysis techniques. Cybersecurity training material should be updated upon making any significant change in the software environment and the developers should be retrained using the updated material.

PS12: The software requirements gathering process should identify support requirements and the software should be designed with graceful degradation.

PS13: The design process should consider the security of the software system and include vulnerability analysis procedures, procedures to securely interface with external systems, and considerations for fault-tolerant designs.

PS14: The software development programming language should consider and evaluate risks inherent in the selected language.

PS15: The software should be designed to handle conflicting or misleading inputs. For example: conflicting temperature readings for the same process element.

PS16: The software security assessment process should include evaluation of the interfaces between software components.

PS17: The software should be built using coding techniques to practice defense in depth through secure coding practices such as regular source code reviews and automated scanning of source code.

PS18: The software should be built using well-defined data structures and should be able to take advantage of built-in programming language features.

PS19: All the source code should be stored in a secure repository and strict access controls should be imposed to only allow authorized users to read, write, and execute.

PS20: All the third-party libraries or open-source software modules that are used to achieve end-product development should be procured from reliable sources. Those libraries and modules should be scanned and analyzed for vulnerabilities.

PS21: All software updates should be regression tested and the test procedures should include input limit (out-of-bounds) testing. The test procedures should also include active scanning, run-time verification tests, performance analysis, stress testing, and software vulnerability testing.

PS22: Software test libraries should be updated to reflect special cases/conditions that trigger “bug-fix” modifications.

PS23: Factory acceptance testing (FAT) should include vulnerability scanning.

PS24: Regression tests should be performed to validate patch installation. Software patch documentation should contain a list of resolved issues.

PS25: End-user training should include integration of the software with other systems (both hardware and software) and methods for monitoring the security of the software.

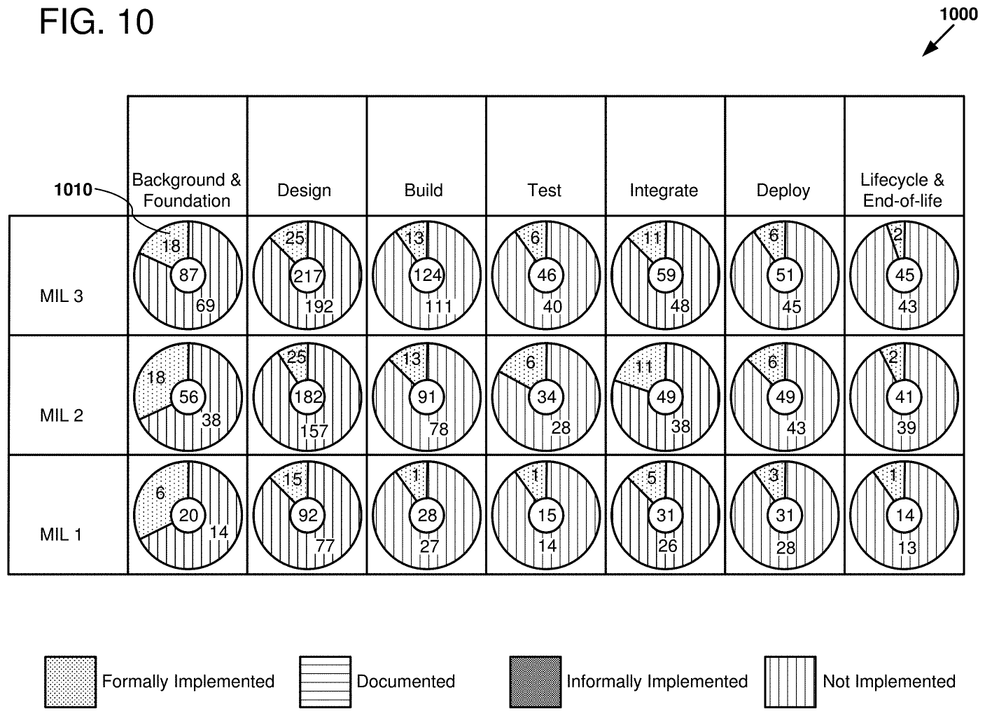

Upon achieving the FI status for all the above-listed best practices, the distribution and overall maturity is as shown in the graphical user interface display 1000 of FIG. 10. It can be observed in FIG. 10 that the numbers in the portions shaded as formally implemented (e.g., pie slice 1010) of the pies are different for MIL1 and MIL2 but remained unchanged for MIL3. This is because not all of the MIL3 best practices are FI. Based on the implementation shown in FIG. 10, improvements across each domain are shown in Table 6 and the CWEs addressed because of the improvements are shown in Table 7. Note that the best practices that are FI are only related to buffer overflow attack. Therefore, with respect to buffer overflow attacks, the organization is at MIL2. However, it can be seen in FIG. 10 that not all the best practices from MIL1 and MIL2 are FI. Therefore, the overall grade of NewOrgSoft still remains at MIL0.

TABLE 6
Cybersecurity improvements achieved by date D 3

| Domain | Total | FI | % Improve |
|---|---|---|---|
| Background and Foundation | 87 | 18 | ~21% |
| Design | 217 | 25 | ~12% |
| Build | 124 | 13 | ~11% |
| Test | 46 | 6 | ~13% |
| Integrate | 59 | 11 | ~19% |
| Deploy | 51 | 6 | ~12% |
| Lifecycle and End-of-Life | 45 | 2 | ~4% |

TABLE 7
CWE evaluation for MIL2 at date D 3

| CWE | Status | Related PS |
|---|---|---|
| CWE-120 | D | 11, 14, 15, 17, 18, 19 |
| CWE-190 | FI | 14, 15, 17, 18 |
| CWE-131 | FI | 15, 17 |
| CWE-798 | D | 11, 13 |
| CWE-129 | FI | 14, 21 |
| CWE-789 | FI | FI IN MIL1 |
| CWE-120 | D | 11, 14, 15, 17, 18, 19 |
| CWE-120 | D | 11, 14, 15, 17, 18, 19 |

5. MIL2 Best Practices Related to Buffer Overflow Attack

By successfully reaching the target MIL2 state by date D3, NewOrgSoft set a new target to reach MIL3before 6 months from the date D3 (i.e., by date D4 in Table 2). To achieve MIL3 with respect to buffer overflow attacks, in addition to the previously stated best practices (MIL1 and MIL2), the following MIL3 best practices are required to achieve the state of FI. Achieving MIL3 indicates that NewOrgSoft has holistic defensive systems in place to protect and defend against the attacks from AttackBuffers.

PS26: In-depth cybersecurity training course modules should be in place for the software development and testing tasks. Cybersecurity training topics should also include source code analysis tools.

PS27: Software developers should receive annual refresher training in secure coding concepts.

PS28: The software design process should consider misuse mitigation during the development process.

PS29: The software should be designed with fault resilience (component restart). The programming language selection should consider issues raised in ISO/IEC 24772 [9].

PS30: The software should be designed to prevent the spread of faults and the software assessment process should include additional security attributes.

PS31: The software designs should be red-teamed to detect unanticipated design vulnerabilities and the designs should include methods to determine if the software is under attack. The design process should include an attack surface analysis.

PS32: The software should be built with defensive coding techniques and all the third-party libraries or open-source software modules that are used to achieve the end-product development should be scanned with static and dynamic software analysis tools for malicious code.

PS33: The software test procedures should include stress testing and input fuzzing testing.

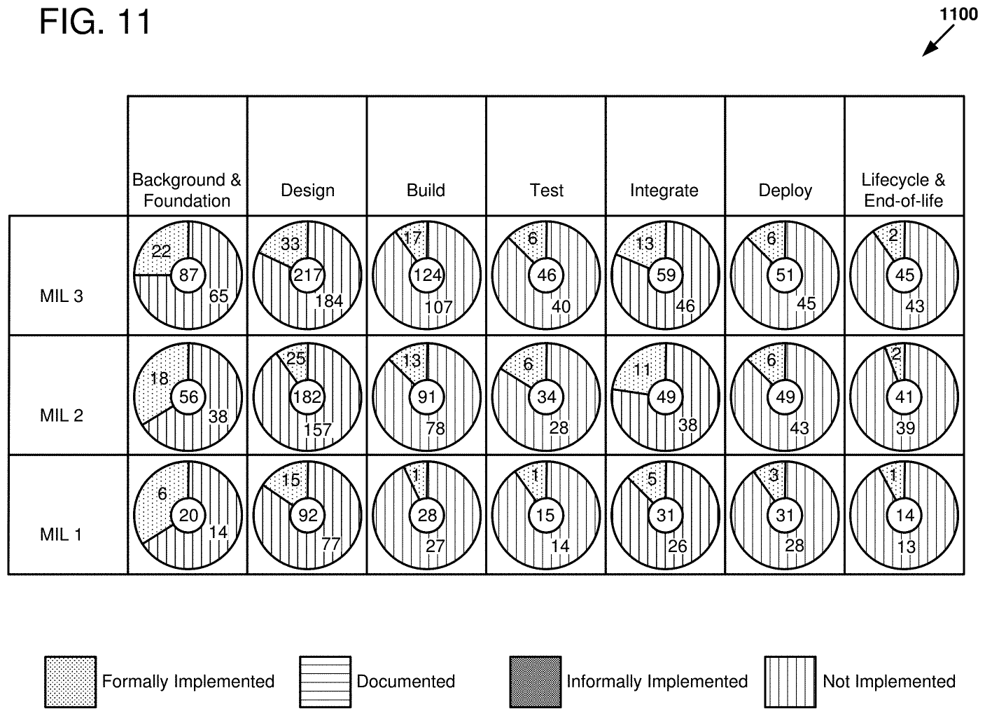

The overall maturity of the facility after achieving the FI status for all the above-listed best practices is shown in the graphical user interface display 1100 of FIG. 11. As shown in FIG. 11, the numbers in the green portion of the pies are different for MIL1, MIL2, and MIL3. This is because at this point, all the best practices related to buffer overflow defense under MIL1, 2, and 3 are FI. However, for the Test, Deploy, and Lifecycle & End-of-Life domains, no change is observed between the MIL2 and MIL3 statuses (compare FIG. 10 to FIG. 11). This indicates that those three domains do not have any MIL3 best practices related to buffer overflow attacks. Based on the maturity shown in FIG. 11, improvements across each domain are shown in Table 8 and the CWEs addressed because of the improvements are shown in Table 9. Note that the best practices that are FI are only related to buffer overflow attack. Therefore, with respect to buffer overflow attacks, the organization is at MIL3. However, the overall grade of NewOrgSoft still remains at MIL0.

TABLE 8
Cybersecurity improvements achieved by date D 4

| Domain | Total | FI | % Improve |
|---|---|---|---|
| Background and Foundation | 87 | 22 | ~25% |
| Design | 217 | 33 | ~15% |
| Build | 124 | 17 | ~14% |
| Test | 46 | 6 | ~13% |
| Integrate | 59 | 13 | ~22% |
| Deploy | 51 | 6 | ~12% |
| Lifecycle and End-of-Life | 45 | 2 | ~4% |

TABLE 9
CWE evaluation for MIL3 at date D 4

| CWE | Status | Related PS |
|---|---|---|
| CWE-120 | FI | 27, 29, 33 |
| CWE-190 | FI | FI in MIL2 |
| CWE-131 | FI | FI in MIL2 |
| CWE-798 | FI | 28, 29, 30, 31 |
| CWE-129 | FI | FI in MIL2 |
| CWE-789 | FI | FI in MIL1 |
| CWE-120 | FI | 27, 29, 33 |
| CWE-120 | FI | 27, 29, 33 |

6. Comparative analysis of MIL1, MIL2, and MIL3

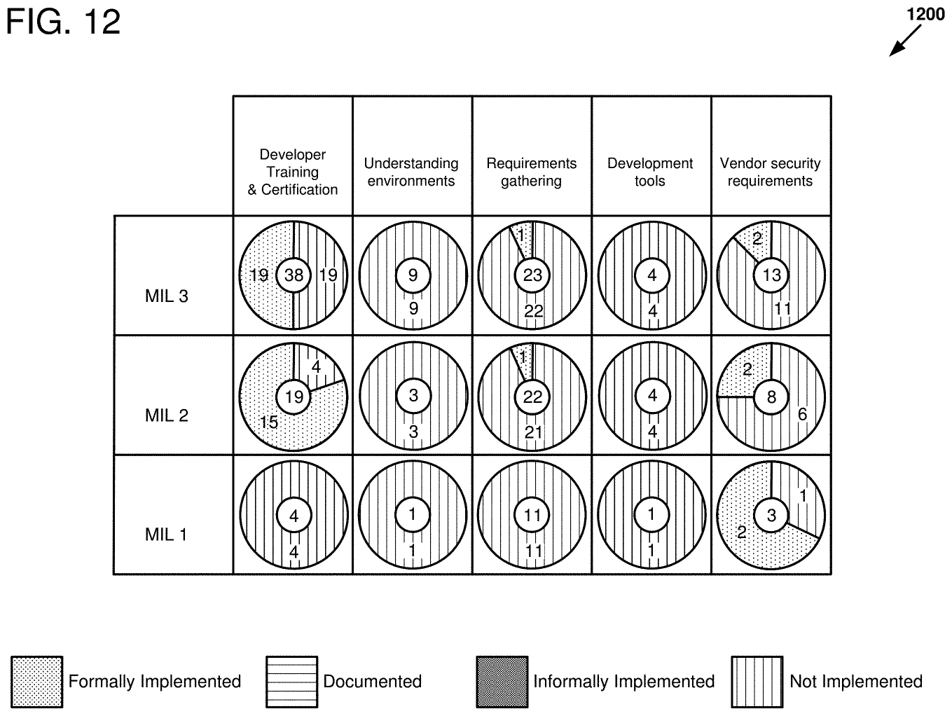

Adoption of best practices is resource and time constrained. Therefore, an organization should target to reach MIL1 as the first objective. Then, the organization should continue progressing to reach MIL2 and finally MIL3. FIGS. 12 through 18 show an in-depth comparative analysis across all the domains between all the fictitious organizations (all the green is related to buffer overflow and the blue is not related to buffer overflow).

As shown in FIG. 12, for the domain Background & Foundation, large concentration of the best practices related to buffer overflow are in the developer and training subdomain followed by vendor security environments and requirements gathering. The subdomains understanding environments and development tools may be of less significance to buffer overflow. It is also evident in FIG. 10 that ˜27% of the best practices related to buffer overflow belongs to MIL1, ˜55% to MIL2, and only ˜18% to MIL3. A very different concentration is observed in the Design domain.

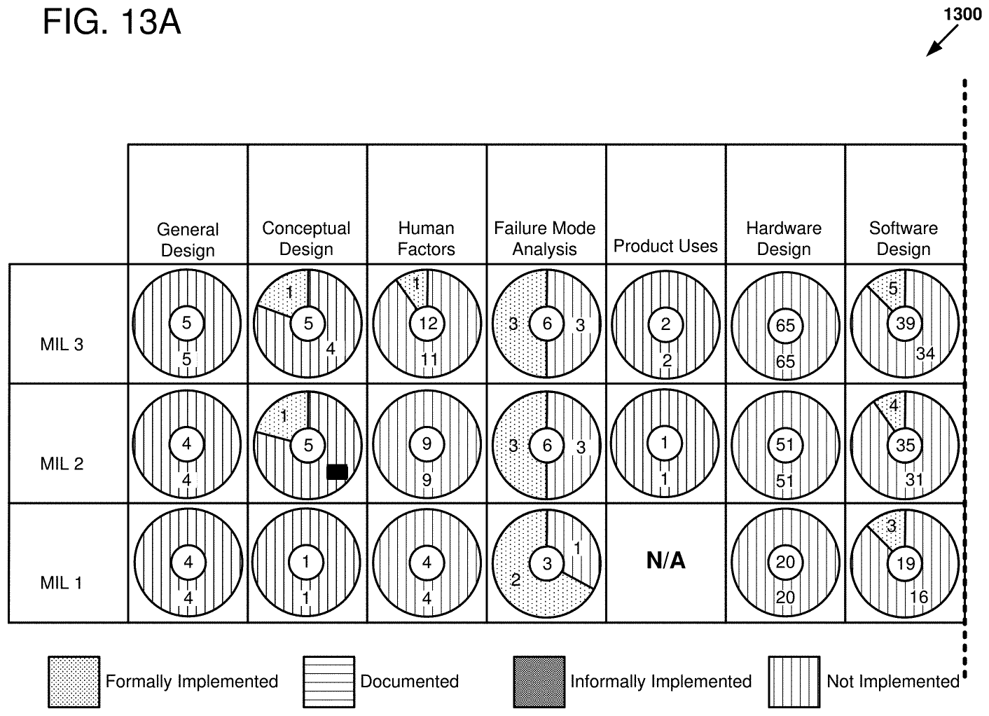

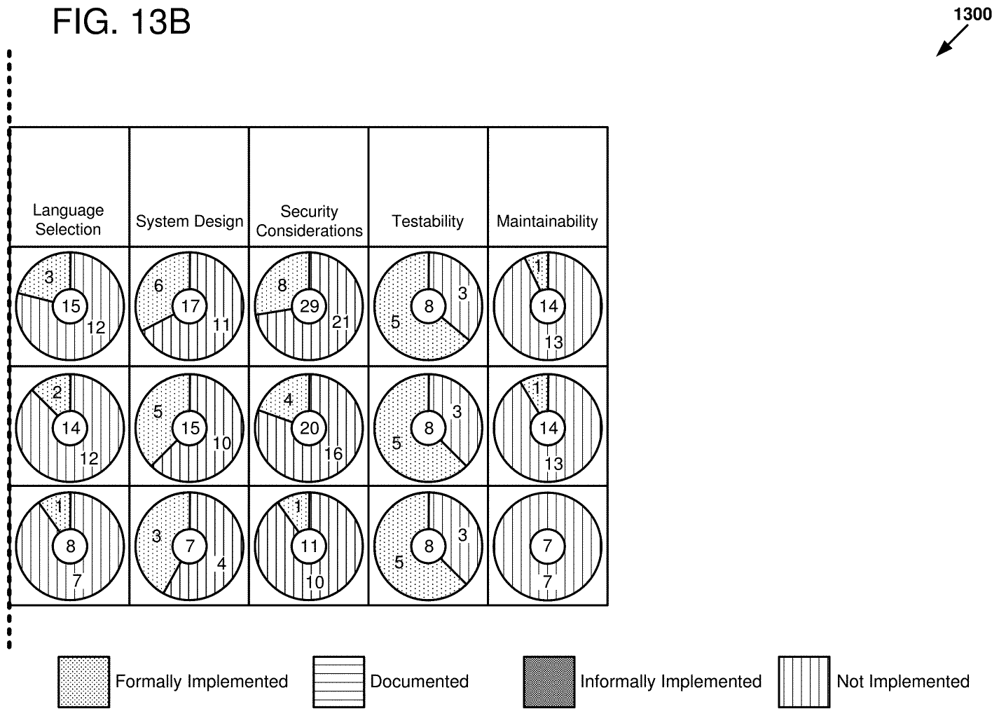

For the Design domain, as shown in the pie summary computer display 1300 of FIGS. 13A-B, most best practices are in security considerations followed by system design, software (and firmware) design, testability, failure mode analysis, language selection, conceptual design, human factors considerations, and maintainability. The subdomains general design, product uses, and hardware design may not be significant to buffer overflow. As shown in the pie summary computer display 1300, ˜39% of the best practices related to buffer overflow belong to MIL1, ˜36% to MIL2, and ˜24% to MIL3.

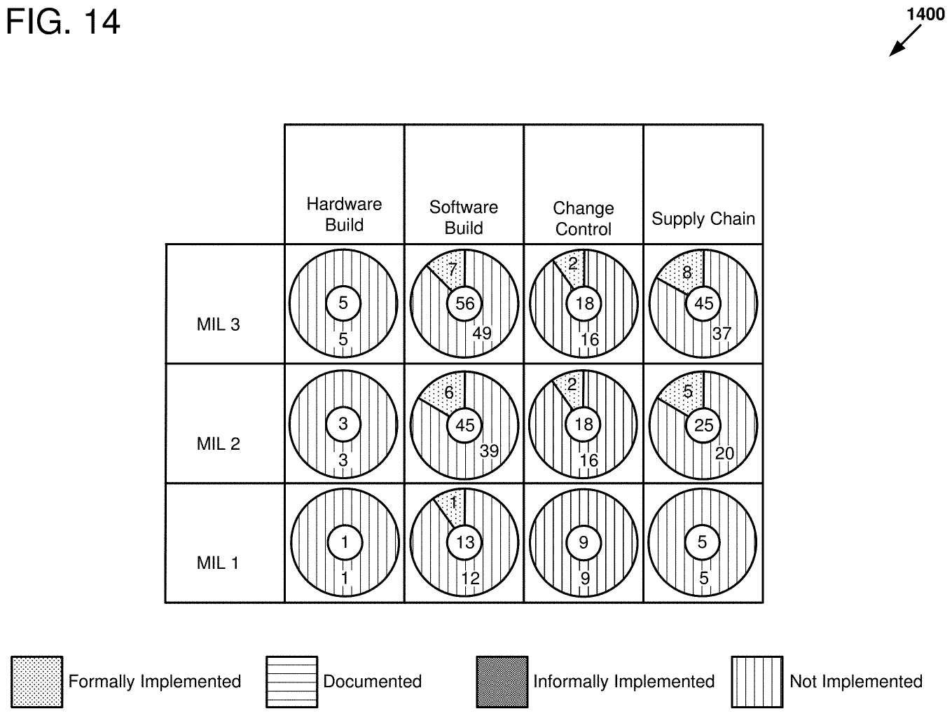

In the Build domain shown in pie summary computer display 1400 of FIG. 14, a large concentration of best practices is in software build followed by supply chain and change control. The subdomain hardware build may not be of any significance to buffer overflow. According to FIG. 14, ˜6% of the best practices related to buffer overflow belong to MIL1, ˜71% to MIL2, and ˜24% to MIL3.

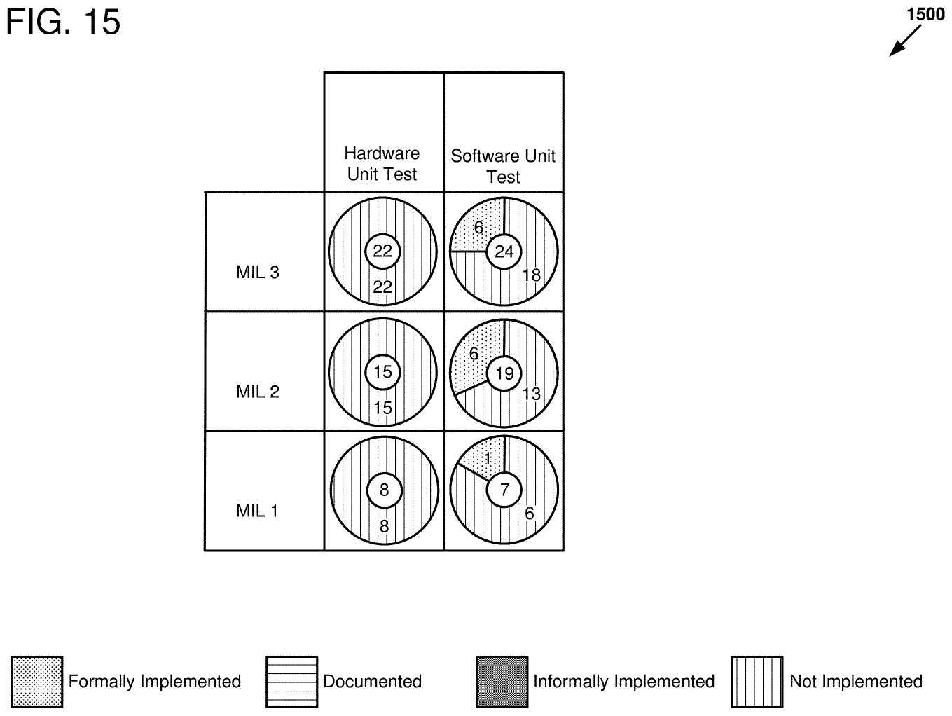

The Test domain has only two subdomains. As shown in in pie summary computer display 1500 of FIG. 15, all the best practices related to buffer overflow attack/defense are in the software (unit) test subdomain. According to FIG. 15, ˜17% of the best practices related to buffer overflow belong to MIL1, ˜83% to MIL2, and 0% to MIL3.

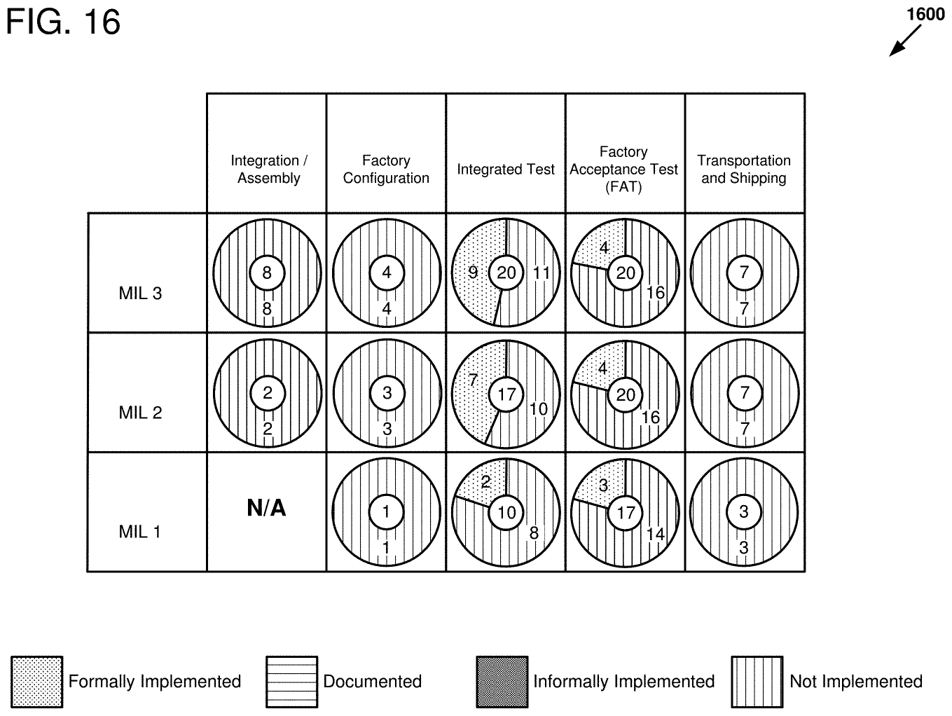

The Integration domain has five subdomains, but the only two that are relevant to buffer overflow attack/defense are integrated test and FAI. As shown in in pie summary computer display 1600 of FIG. 16, ˜39% of the best practices related to buffer overflow belong to MIL1, ˜46% to MIL2, and 15% to MIL3.

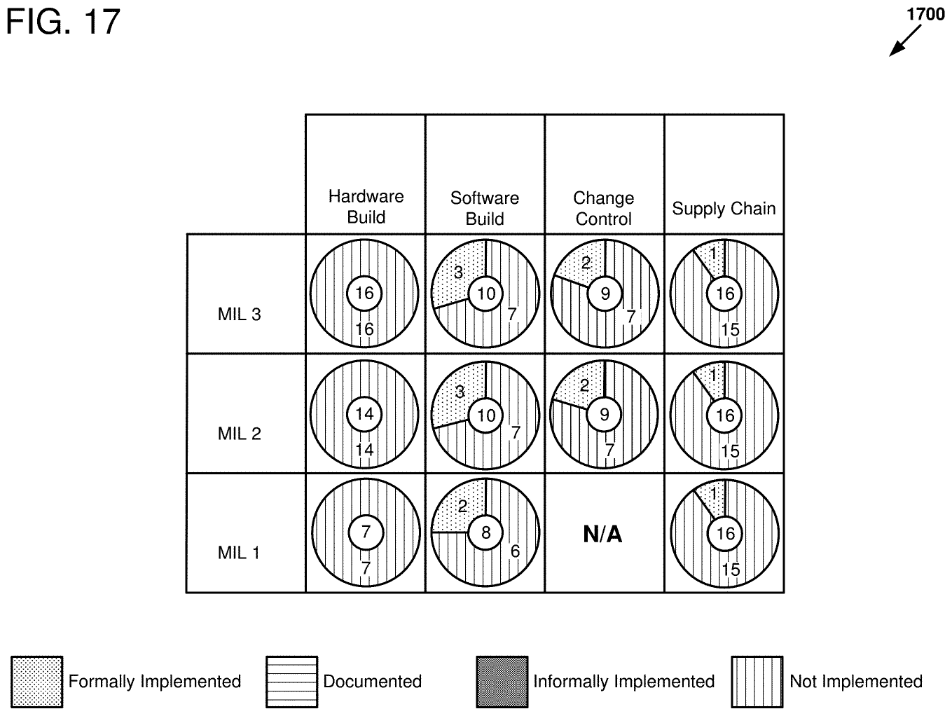

As shown in the pie summary computer display 1700 of FIG. 17, the best practices related to buffer overflow attack/defense are distributed across the site acceptance testing, end-user training, and documentation subdomains. The subdomain end-user configuration is not significant in buffer overflow analysis. According to FIG. 17, 50% of the best practices related to buffer overflow belong to MIL1, 50% to MIL2, and 0% to MIL3.

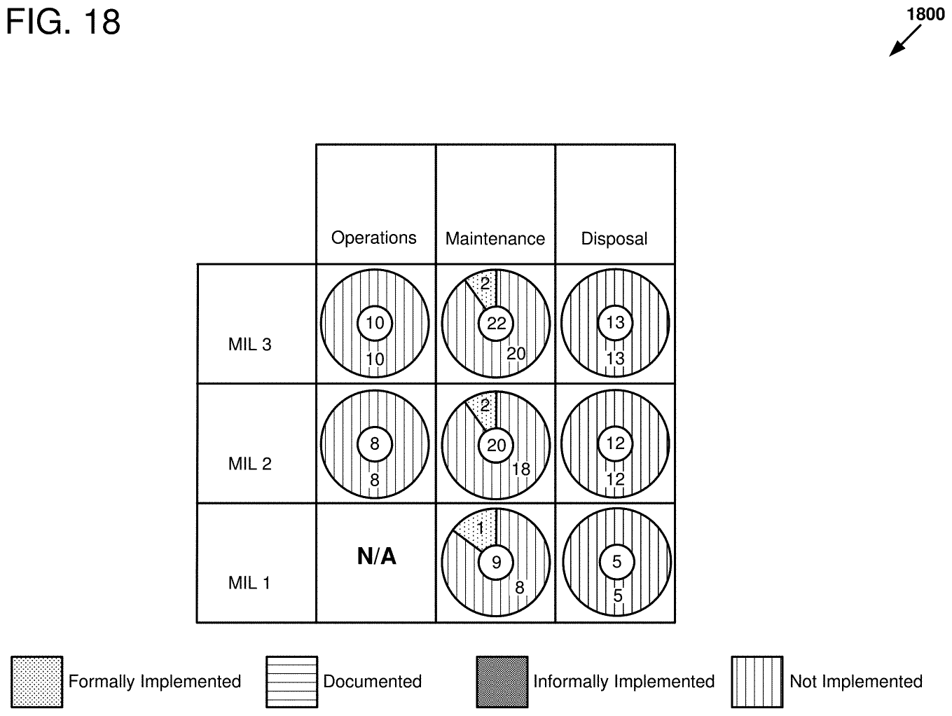

In the final domain, Lifecycle and End-of-Life analysis, shown in the pie summary computer display 1800 of FIG. 18, the only subdomain relevant to buffer overflow attack/defense is maintenance. According to FIG. 18, 50% of the best practices related to buffer overflow belong to MIL1, 50% to MIL2, and 0% to MIL3.

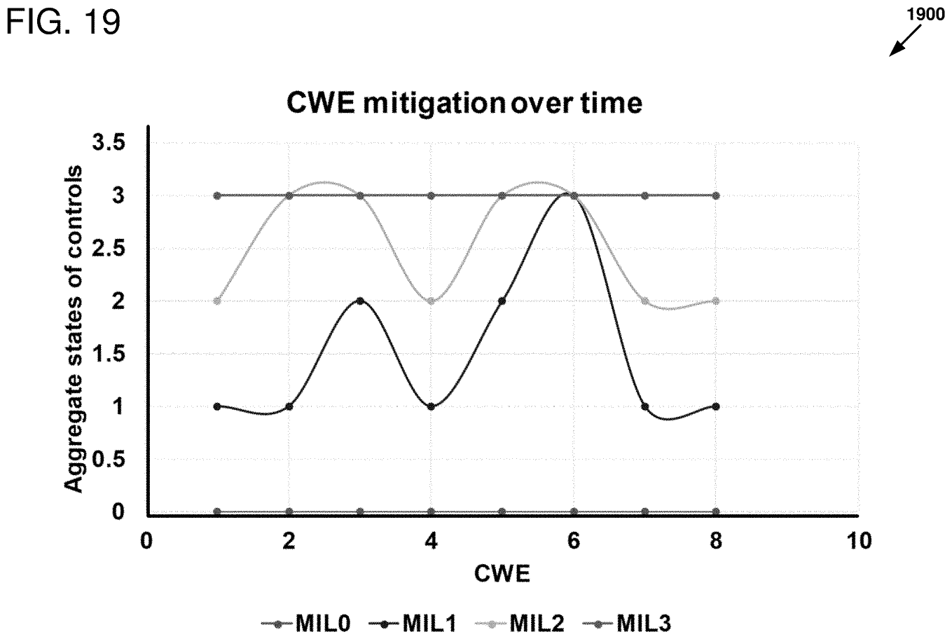

FIG. 19 is a chart 1900 illustrating CWE mitigation over time. Different CWE are plotted along the X axis, while levels of aggregate states of controls is plotted along the Y axis. The plots illustrate the aggregate states of controls for various CWE's for MIL0, MIL1, MIL2, and MIL3, respectively.

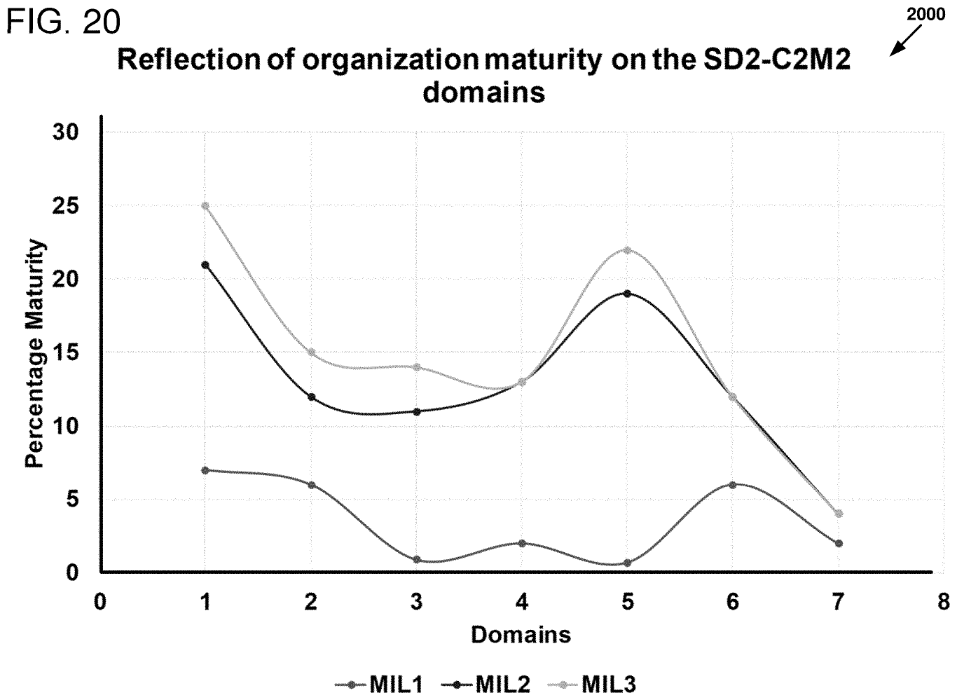

FIG. 20 is a chart 2000 illustrating a reflection of organizational maturity on various domains discussed above. As shown, the individual domains are plotted along the X axis, while the percentage maturity corresponding to this domain at various MIL levels as shown by the plots that correspond to MIL1, MIL2, and MIL3, respectively.

Thus, the disclosed technology provides an easy-to-use tool that facilitates the adoption of cybersecurity in the design and deployment process. Including cybersecurity in the process of developing these systems can help reduce the attack surface of critical systems in U.S. critical energy infrastructure. The case study illustrated using the pie summary examples shown in FIGS. 8-20 and associated text shows how implementing computer systems according to the disclosed technology can prevent a host of cyber vulnerabilities in critical computer infrastructure.

### VIII. Example Computing Environment

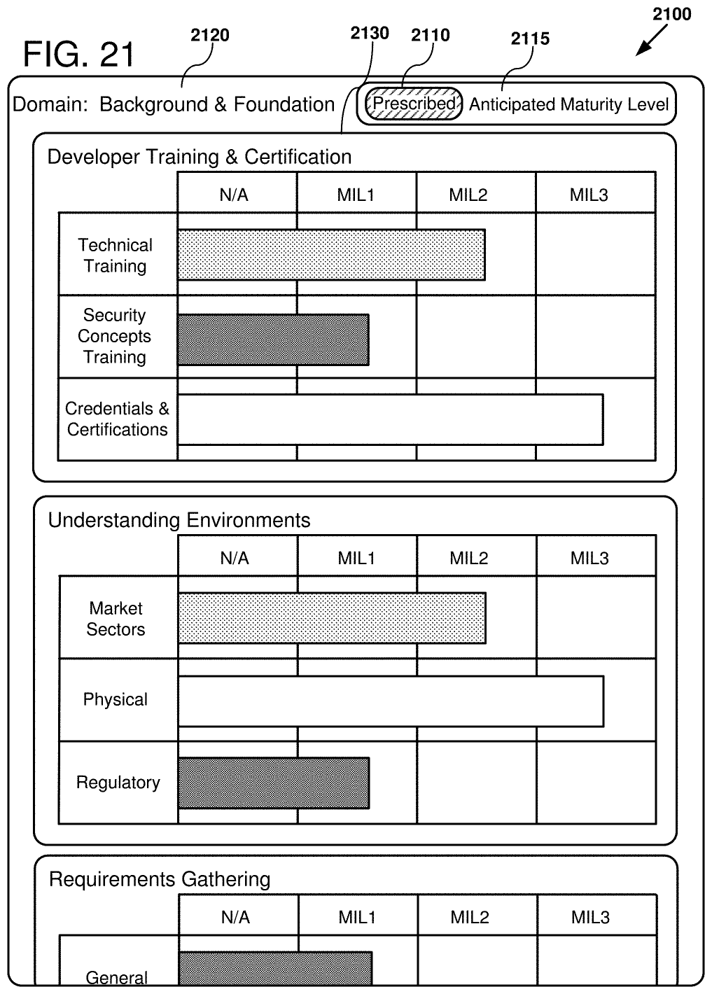

FIG. 21 depicts a computer-implemented graphical display 2100 for selecting and displaying prescribed and anticipated maturity levels, as can be implemented in certain examples of the disclosed technology. As shown, a graphical users interface allows a user to select between selecting and viewing MIL levels for development domains. A tab in the interface allows the user to select between prescribed 2110 and anticipated 2115 maturity levels. Each domain display 2120 includes a display showing the MIL level corresponding to the prescribed or anticipated maturity level, for each subdomain (e.g., subdomain 2130) as selected by the tab 2110.

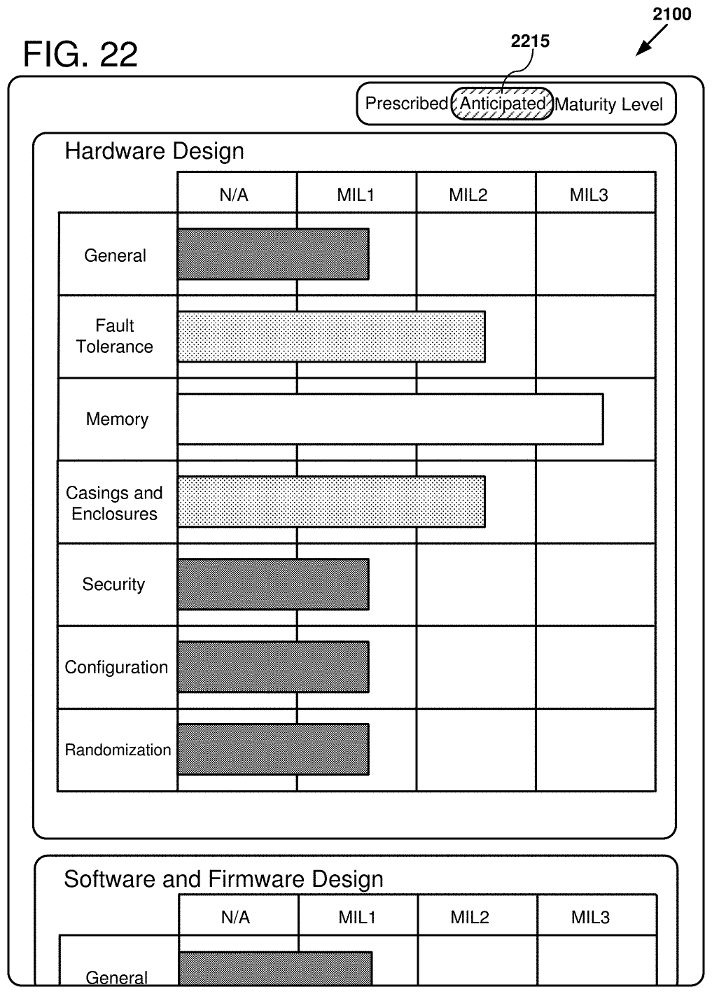

FIG. 22 depicts the computer-implemented graphical display 2100 after a user has selected the anticipated maturity level tab 2115. As shown, the anticipated maturity levels are lower than the prescribed maturity levels for the illustrated domains.

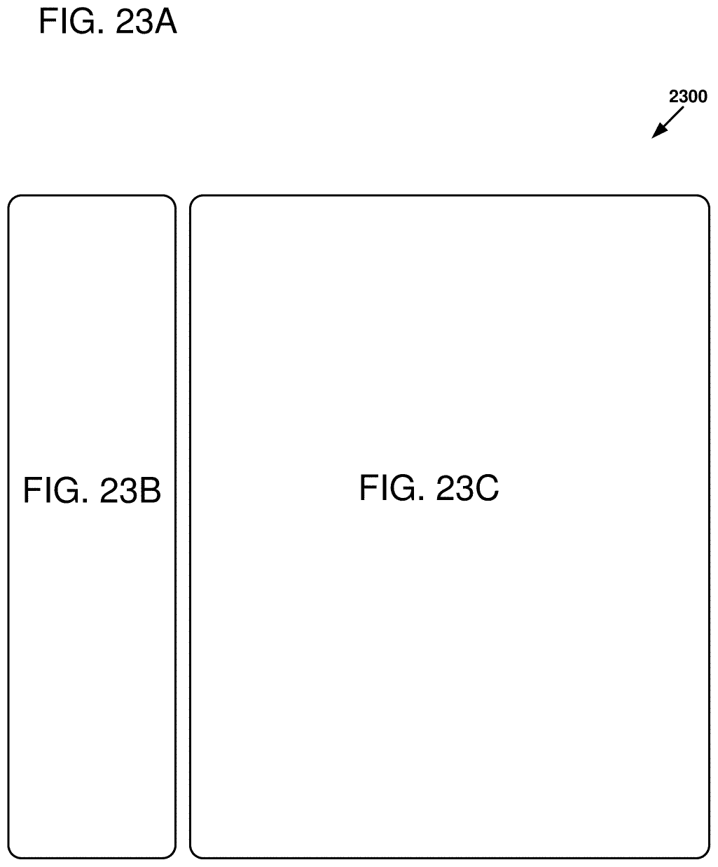

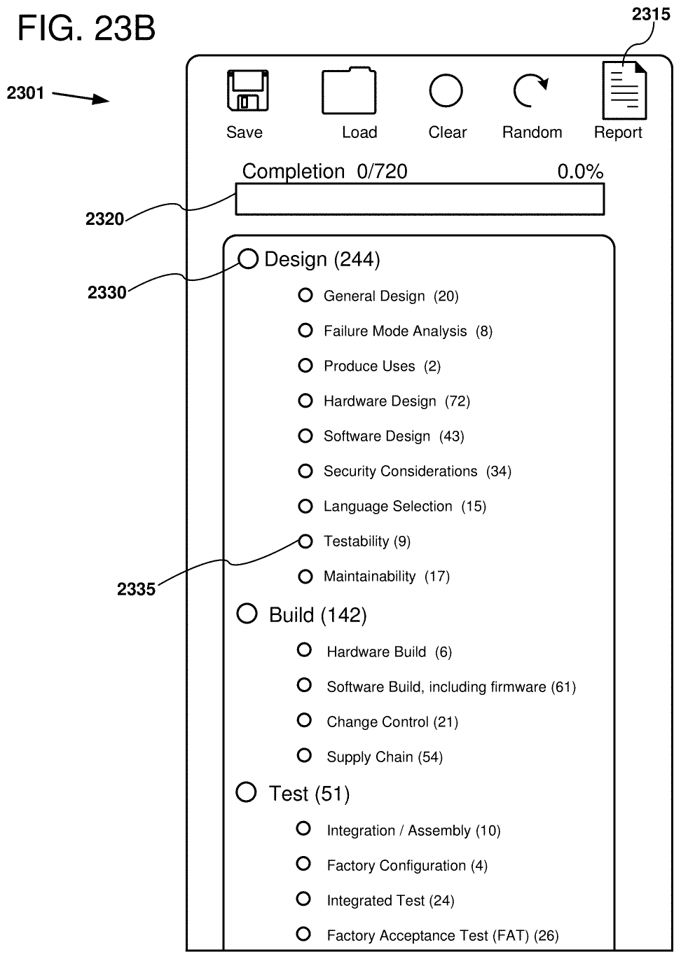

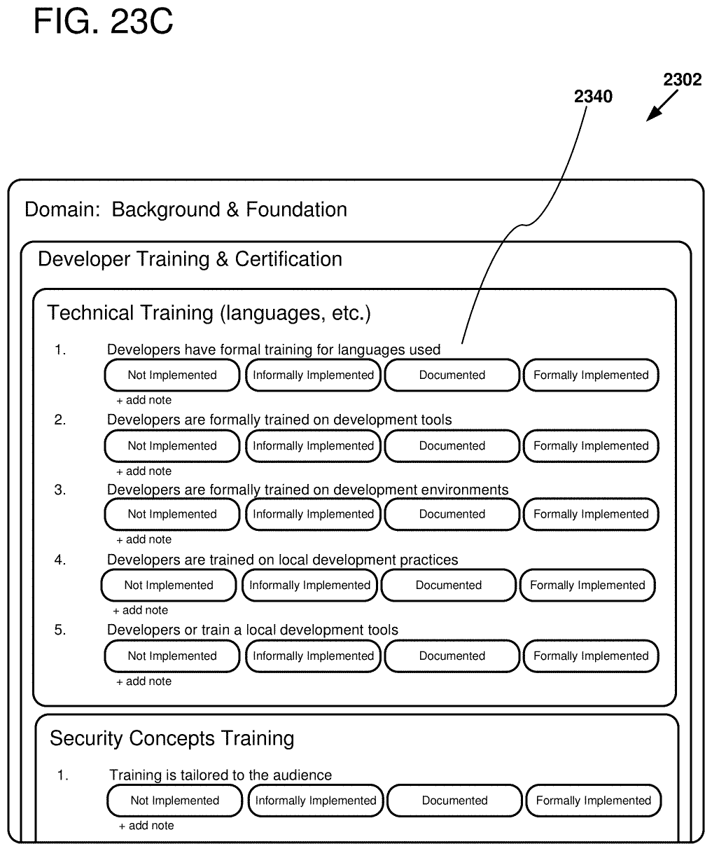

FIGS. 23A-23C depicts a computer-implemented graphical display 2300 for selecting and displaying expected maturity levels, as can be implemented in certain examples of the disclosed technology. A graphical user interface allows developers, administrators, and other such users to select and view expected maturity levels for the various domains. The display 2300 includes a navigation interface 2301, which is further detailed in FIG. 23B, and a interrogatory interface 2302, which is further details in FIG. 23C.

As shown in FIG. 23B, the navigation interface 2301 allows the user to save and load inputs as the development process continues. The user can also produce a report 2315 using the illustrated interface. The interface further includes a completion indicator 2320, which is updated to show progress as the user(s) proceed through the questionnaire process, and allows navigation to specific domains (e.g., design domain 2330) and subdomains (e.g., testability subdomain 2335) of the questionnaire via a selection interface 2340.

Turning to FIG. 23C, the interrogatory interface 2302 provides an input interface allows developers and administrators to provide input on the current state of development of the computing system. For example, the interface provides five multiple choice questions regarding technical training in the developer training & certification subdomain. Input provided can be mapped to the managerial input on expected and anticipated maturity levels to determine actual levels of maturity for the project, and provide concrete recommendations and actions for increasing the maturity levels.

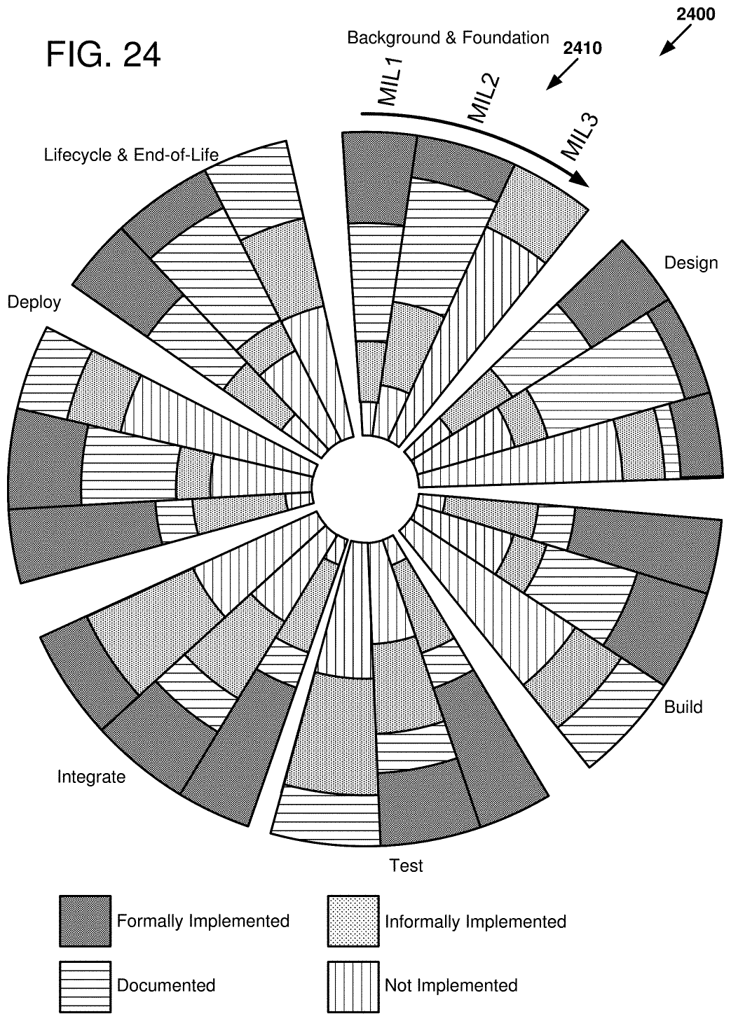

FIG. 24 depicts a computer-implemented graphical user interface 2400 displaying an alternative arrangement of a pie summary chart, as can be implemented in certain examples of the disclosed technology. In this example, the status for seven domains is displayed. For example, for the background and foundation domain, a wedge 2410 of the pie shows the level of not implemented, informally implemented, documented, and formally implemented for each MIL level. As shown, the displays for increasing MIL levels, in a clockwise order, are shown for each domain. The area of each subwedge corresponding to a development level is scaled according to the level of completion for the respective MIL level. In this example, the areas are normalized so that each MIL subwedge occupies the same area. In other examples, the radius or area of the subwedge can be adjusted proportional to the number of components of the particular level.

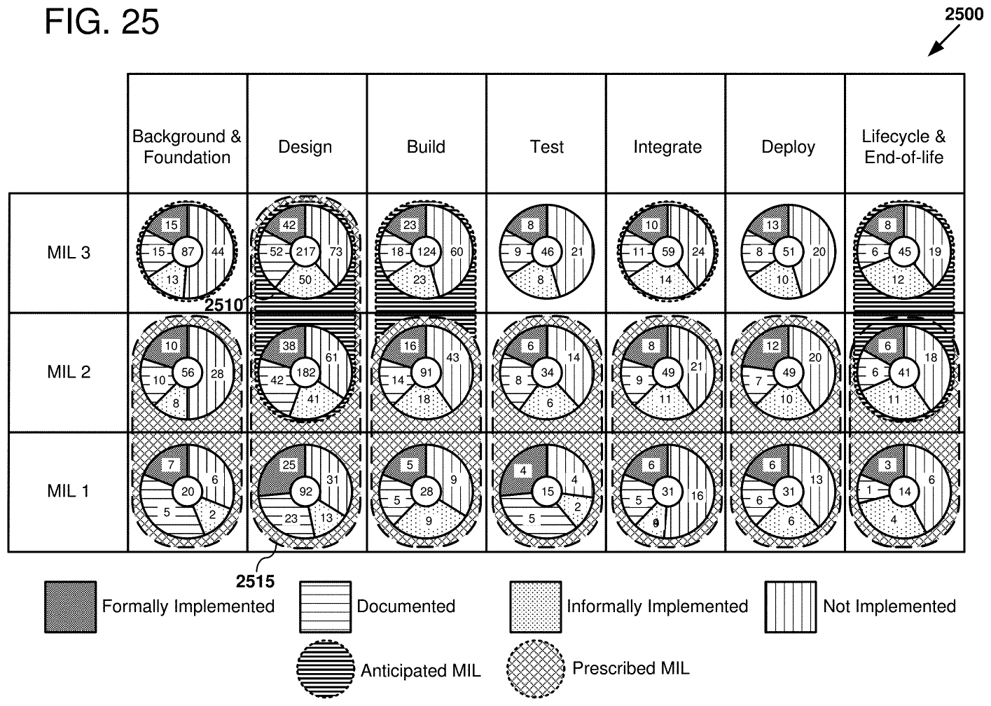

FIG. 25 depicts a computer-implemented graphical user interface 2500 displaying an alternative arrangement of a pie summary chart, as can be implemented in certain examples of the disclosed technology. The arrangement of the pie summaries is similar to that discussed above regarding FIG. 6. However, in this example, the display also includes an indication of the status of domains covered by anticipated MIL (e.g., anticipated MIL 2510 of the Design domain) and prescribed MIL (e.g., prescribed MIL 2515 of the Design domain).

### IX. Example Computing Environment

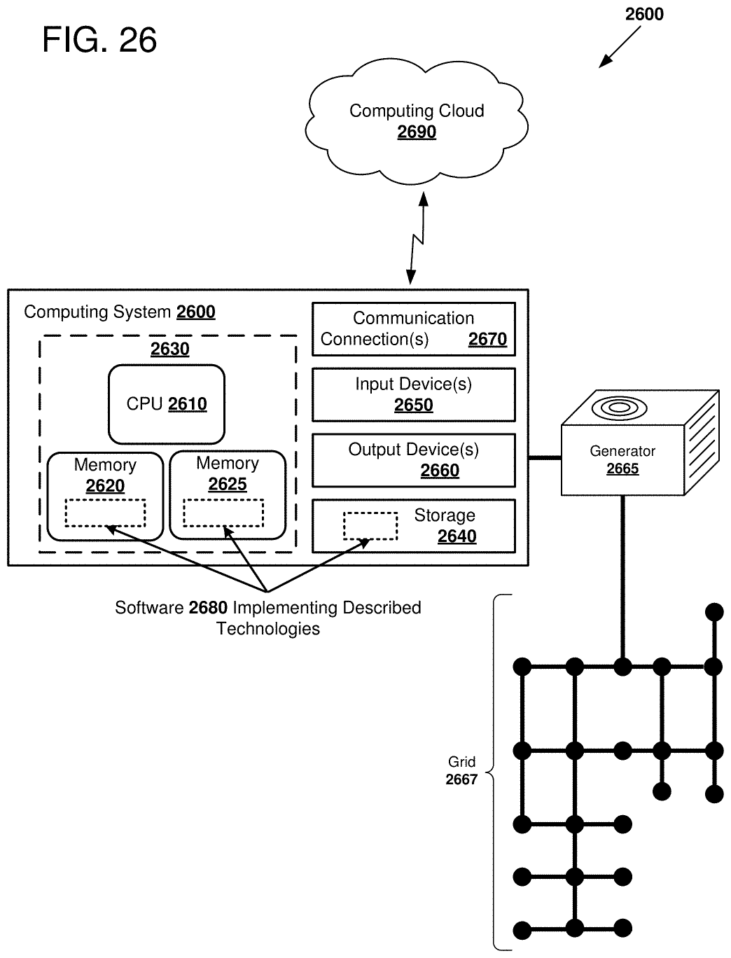

FIG. 26 illustrates a generalized example of a suitable computing environment 2600 in which described embodiments, techniques, and technologies, including selecting and using domains and MILs, reconfiguring computing devices, and addressing vulnerabilities, as discussed above. For example, the computing environment 2600 can be used to implement any of the computing devices deployed to users or compute resources as discussed above regarding FIG. 1.

The computing environment 2600 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 26, the computing environment 2600 includes at least one central processing unit 2610 and memory 2620. In FIG. 26, this most basic configuration 2630 is included within a dashed line. The central processing unit 2610 executes computer-executable instructions and may be a real or a virtual processor. The central processing unit 2610 can be a general-purpose microprocessor, a microcontroller, or other suitable processor. In a multi-processing system, multiple processing units execute computer-executable instructions to increase processing power and as such, multiple processors can be running simultaneously. The memory 2620 may be volatile memory (e.g., registers, cache, RAM), non-volatile memory (e.g., ROM, EEPROM, flash memory, etc.), or some combination of the two. The memory 2620 stores software 2680, parameters, and other data that can, for example, implement the technologies described herein. A computing environment may have additional features. For example, the computing environment 2600 includes storage 2640, one or more input devices 2650, one or more output devices 2660, and one or more communication connections 2670. The computing environment 2600 can be coupled to a generator 2665 and/or electrical grid 2667 (e.g., a microgrid). An interconnection mechanism (not shown) such as a bus, a controller, or a network, interconnects the components of the computing environment 2600. Typically, operating system software (not shown) provides an operating environment for other software executing in the computing environment 2600, and coordinates activities of the components of the computing environment 2600.

The storage 2640 may be removable or non-removable, and includes magnetic disks, magnetic tapes or cassettes, CD-ROMs, CD-RWs, DVDs, or any other medium which can be used to store information and that can be accessed within the computing environment 2600. The storage 2640 stores instructions for the software 2680, which can be used to implement technologies described herein.

The input device(s) 2650 may be a touch input device, such as a keyboard, keypad, mouse, touch screen display, pen, or trackball, a voice input device, a scanning device, or another device, that provides input to the computing environment 2600. For audio, the input device(s) 2650 may be a sound card or similar device that accepts audio input in analog or digital form, or a CD-ROM reader that provides audio samples to the computing environment 2600. The input device(s) 2650 can also include sensors and other suitable transducers for generating data about the generator 2665 and/or grid 2667, for example, voltage measurements, frequency measurements, current measurements, temperature, and other suitable sensor data. The output device(s) 2660 may be a display, printer, speaker, CD-writer, or another device that provides output from the computing environment 2600. The output device(s) 2660 can also include interface circuitry for sending commands and signals to the generators, for example, to increase or decrease field excitation voltage or output voltage of the generator.

The communication connection(s) 2670 enable communication over a communication medium (e.g., a connecting network) to another computing entity. The communication medium conveys information such as computer-executable instructions, compressed graphics information, video, or other data in a adjusted data signal. The communication connection(s) 2670 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controllers and coordinators. Both wired and wireless connections can be implemented using a network adapter. In a virtual host environment, the communication(s) connections can be a virtualized network connection provided by the virtual host. In some examples, the communication connection(s) 2670 are used to supplement, or in lieu of, the input device(s) 2650 and/or output device(s) 2660 in order to communicate with the generators, sensors, other controllers and AVRs, or smart grid components.

Some embodiments of the disclosed methods can be performed using computer-executable instructions implementing all or a portion of the disclosed technology in a computing cloud 2690. For example, immediate response functions, such as generating regulation signals or field excitation signals can be performed in the computing environment while calculation of parameters for programming the controller can be performed on servers located in the computing cloud 2690.

Computer-readable media are any available media that can be accessed within a computing environment 2600. By way of example, and not limitation, with the computing environment 2600, computer-readable media include memory 2620 and/or storage 2640. As should be readily understood, the term computer-readable storage media includes the media for data storage such as volatile memory 2620, non-volatile memory 2625, and storage 2640, and not transmission media such as adjusted data signals.

### X. Alternative Example Display and Controls

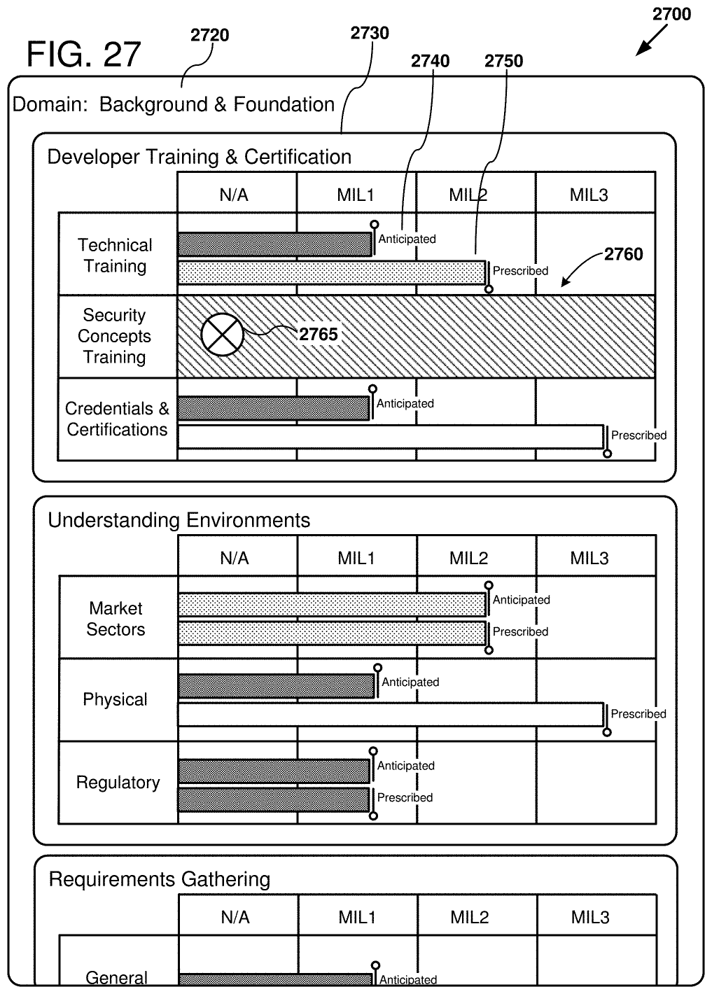

FIG. 27 depicts a computer-implemented graphical display for selecting and displaying prescribed and anticipated maturity levels, as can be implemented in certain examples of the disclosed technology. In particular, the graphical display 2700 is an alternative version of the graphical display discussed above regarding FIG. 21.

As shown, a graphical user interface allows a user to select between selecting and viewing MIL levels for development domains (e.g., Background & Foundation domain 2720) and subdomains (e.g., Developer Training and Certification 2730). Instead of using a tab as in the display 2100, the illustrated display provides control bars (e.g., control bars 2740 and 2750) allowing a user to select levels for anticipated and prescribed MILs. For example, for the technical training subdomain, the user can use a first control 2740 to select the anticipated level MIL for the subdomain. Similarly, the user can use a second control 2750 to select the prescribed MIL for the subdomain. Further, if a subdomain is not applicable, as shown by the grade area 2760, the user can use a control 2765 to switch between the category being applicable and not applicable.

### XI. Alternative MIL Summary Display

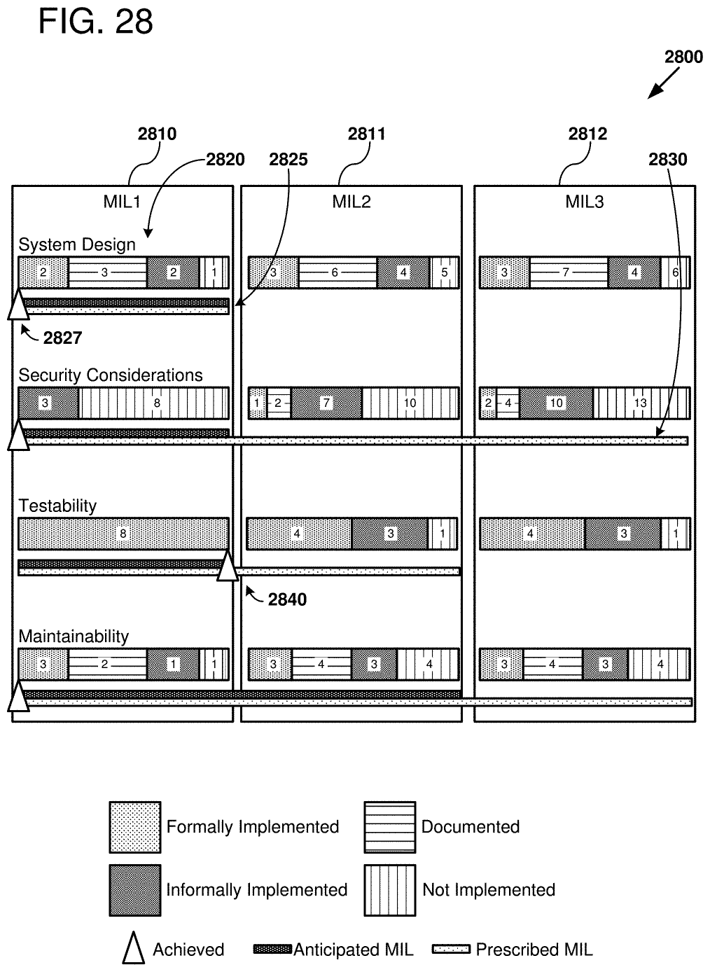

FIG. 28 is a depiction of a computer-implemented graphical user interface display of a MIL summary display 2800, as can be implemented in certain examples of the disclosed technology. As shown in FIG. 28, the MIL summary display 2800 provides a brief overview of the evaluation results. The MIL summary display 2800 can be displayed using a graphical user interface or other computer display, as a graphical representation in a stored report file, or in any other suitable format. As shown in the example of FIG. 28, a number of indicator bars are organized by MIL level and subdomain for a selected domain. As shown, there is a different column allocated to each MIL level 2810-2812. For example, for the system design subcategory, a first indicator bar 2820 shows that the subdomain has two items formerly implemented, three items documented, two items informally implemented, and one item not implemented for the MIL1 level specification. For each subdomain, an indicator 2825 also shows the anticipated and prescribed MIL levels. A triangular indicator 2827 indicates that MIL1 has not been achieved for the system design subdomain. As another example, for the security considerations subdomain, the prescribed MIL level is MIL3, as shown by the indicator 2830. As another example, for the testability subdomain, a triangular indicator 2840 shows that level MIL1 has been achieved for the subdomain.

In view of the many possible embodiments to which the principles of the disclosed subject matter may be applied, it should be recognized that the illustrated embodiments are only preferred examples and should not be taken as limiting the scope of the scope of the claims to those preferred examples. Rather, the scope of the claimed subject matter is defined by the following claims. We therefore claim as our invention all that comes within the scope of these claims.

What is claimed is:

1. A method comprising:
with a computer:
producing management priority data indicating a respective prescribed maturity level for a plurality of enumerated domains in a computing environment;
producing technical assessment data indicating an expected maturity level for each of the plurality of domains in the computing environment; and
evaluating the management priority data and the technical assessment data to produce at least one recommended configuration change to modify the computing environment, the recommended configuration change being selected to reduce susceptibility of the computing environment to at least one vulnerability.

2. The method of claim 1, further comprising performing an operation in the computing environment to implement the recommended configuration change.

3. The method of claim 1, further comprising producing management priority data indicating a respective anticipated maturity level for a plurality of enumerated domains in a computing environment.

4. The method of claim 1, further comprising, with the computer, providing a user interface to display a representation of at least one of the enumerated domains and a user interface control to receive user input selecting a respective prescribed maturity level for a corresponding enumerated domain.

5. The method of claim 1, further comprising, with a user interface, displaying an indicator of maturity level for each of the plurality of domains.

6. The method of claim 1, further comprising, with a user interface, displaying an indicator of maturity level for each of the plurality of domains, at least one of the displayed indicators including a display of two or more maturity criteria for its respective expected maturity level.

7. The method of claim 1, further comprising, with the computer, providing a user interface to display a representation of at least one of the enumerated domains and to display an indicator of a remediation operation selected based on a respective expected maturity level for a corresponding enumerated domain.

8. The method of claim 7, further comprising performing the indicated remediation operation for at least one computing resource object.

9. The method of claim 8, further comprising, after the performing the indicated remediation operation:
repeating the operations of producing management priority data, producing technical assessment data, and evaluating the management priority data; and
performing an additional operation in the computing environment to implement a recommended configuration change produced by repeating the operation of evaluating the management priority data.

10. The method of claim 1, wherein:
the plurality of enumerated domains comprises at least two of:
a background and foundation domain specifying development criteria for at least one of: developer training, developer certification, requirements gathering, vendor security, or development tools;
a design domain specifying development criteria for at least one of: security, computer language selection, testability, maintainability, software and/or firmware design, failure mode analysis, human factors, hardware design, or system design;
a build domain specifying development criteria for at least one of: hardware build, software and/or firmware build, supply change, or change control;
a test domain specifying development criteria for at least one of: hardware unit test or software unit test;
an integration domain specifying development criteria for computing and/or software modules comprising at least one of: integration; test; factory acceptance testing; factory configuration, or transmission of computer-executable instructions;
a deployment domain specifying development criteria for at least one of: end-user configuration, documentation, site acceptance testing, or end-user training; or
a lifecycle domain specifying development criteria for at least one of: operations, maintenance, or disposal.

11. The method of claim 1, further comprising identifying and resolving cybersecurity weaknesses by performing prioritized vulnerability mitigation analysis based on logical constructs and multitiered mathematical filters using a preselected quantitative rank-based criteria methodology, the preselected quantitative rank-based criteria methodology comprising combining multi-criteria dimension analysis techniques with rank-weight methods.

12. One or more computer-readable storage devices or memory storing computer-executable instructions that when executed by the computer, cause the computer to perform the method of claim 1.

13. An apparatus comprising:
memory;
at least one processor; and
one or more computer-readable storage devices or memory storing computer-executable instructions that when executed by the computer, cause the computer to automatically produce an indication of a configuration change to mitigate a potential vulnerability in a computing environment, the instructions comprising:
instructions that cause the processor to produce priority data indicating a selected prescribed maturity level for a set of enumerated domains in the computing environment;
instructions that cause the processor to produce expected maturity level data indicating actual levels of maturity for computing resources in the computing environment for the set of enumerated domains; and
instructions that cause the processor to produce the indication of the configuration change to mitigate the potential vulnerability by mapping the selected prescribed maturity level to the expected maturity level data and selecting a configuration change that is not currently implemented in the computing environment.

14. The apparatus of claim 13, wherein the computer-readable storage devices or memory further comprise:
instructions that cause the computer to automatically implement the configuration change for at least one of the computing resources.

15. The apparatus of claim 13, further comprising:
a video adapter coupled to a display; and
wherein the computer-readable storage devices or memory further comprise:
instructions that cause the processor to provide a user interface using the display, the user interface comprising a representation of at least one of the enumerated domains and a user interface control to receive user input selecting a respective prescribed maturity level for a corresponding enumerated domain.

16. The apparatus of claim 15, wherein the computer-readable storage devices or memory further comprise instructions that cause the processor to provide a user interface using the display, the user interface comprising:
a table representation of the enumerated domains and prescribed levels of maturity associated with the enumerated domains; wherein
for each pair of the enumerated domains and the prescribed levels of maturity, a graphic indicator indicating the actual level of maturity associated with the respective pair.

17. The apparatus of claim 16, wherein the graphic indicator is a pie graph including a numerical display of actual levels of maturity and a sum of the actual levels of maturity for the respective pair.

18. The apparatus of claim 17, where the graphic indicator further comprises a pie summary display including maturity levels for plural domains, including wedges showing relative levels of implementation for each MIL level in the domain.

19. A computing system comprising:
means for producing management priority data indicating a respective prescribed maturity level for a plurality of enumerated domains in a computing environment;
means for producing technical assessment data indicating an expected maturity level for each of the plurality of domains in the computing environment; and
means for evaluating the management priority data and the technical assessment data to produce at least one recommended configuration change to modify the computing environment, the recommended configuration change being selected to reduce susceptibility of the computing environment to at least one vulnerability.

20. The computing system of claim 19, further comprising:
means for automatically performing the at least one recommended configuration change in the computing environment to mitigate susceptibility of the computing environment to the at least one vulnerability.
